(19) United States
(12) Patent Application Publication
(10) Pub. No.: US 2026/0073203 A1
(43) Pub. Date: Mar. 12, 2026

(54) EMBEDDING NEURAL NETWORK ON SILICON THROUGH INTEGRATED RANDOM-ACCESS MEMORY MULTIPLY-ADDER

(71) Applicant: Intel Corporation, Santa Clara, CA (US)

(72) Inventors: Yaron Klein, Rosh Haayin (IL); John Crouter, Fair Oaks, CA (US); Yuval Vered, Tel-Aviv (IL); Yoni Elron, Hadera (IL); Avi Salmon, Kiriat Ata (IL)

(73) Assignee: Intel Corporation, Santa Clara, CA (US)

(21) Appl. No.: 19/389,907

(22) Filed: Nov. 14, 2025

Related U.S. Application Data
(60) Provisional application No. 63/757,096, filed on Feb. 11, 2025.

(51) Int. Cl. G06N 3/0499; G06F 7/544; G06N 3/10

(52) U.S. Cl. CPC G06N 3/0499; G06F 7/5443; G06N 3/10

(57) ABSTRACT

Integrated cells may perform matrix multiplication (MatMul) operations. An integrated cell may include a random-access memory (RAM) cell, dot product unit(s), multiplexer(s), adder, route-in unit, control unit, and vector machine. The RAM cell may store weights and activations. The dot product unit(s) may compute dot products from the weights and activations. The adder may accumulate the dot products. The route-in unit may facilitate data transfer from the RAM cell to the dot product unit(s) or data transfer from another integrated cell to the integrated cell. The control unit may manage memory operations and detect and repair errors in memory operations. The vector machine may provide instructions to the dot product unit(s) and multiplexers to direct the flow of multiply-accumulate operations. Counters may be used to control weight fetching from RAM cells. A MatMul operation may be decomposed, and the integrated cells may perform the MatMul operation through multiple clock cycles.

### CROSS-REFERENCE TO RELATED APPLICATION

This application claims the benefit of U.S. Provisional Patent Application No. 63/757,096, filed Feb. 11, 2025, and titled “HARDWARE NEURAL NETWORK WITH RANDOM-ACCESS MEMORY MULTIPLY-ADD UNIT ARCHITECTURE,” which is incorporated by reference in its entirety for all purposes.

### TECHNICAL FIELD

This disclosure relates generally to artificial intelligence (AI), and more specifically, embedding neural networks (also referred to as “deep neural networks” or “DNNs”) on silicon through integrated random-access memory (RAM) multiply-adders.

### BACKGROUND

DNNs are used extensively for a variety of AI applications ranging from natural language processing to computer vision, speech recognition, and image processing due to their ability to achieve high accuracy. However, the high accuracy comes at the expense of significant computation cost. DNNs have extremely high computing demands as there can be a large number of operations as well as a large amount of data to read and write. Therefore, techniques to improve efficiency of DNNs are needed.

### BRIEF DESCRIPTION OF THE DRAWINGS

Embodiments can be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an integrated circuit (IC) device that implements a model on silicon, in accordance with various embodiments.

FIG. 2A illustrates three-dimensional (3D) memory and logic integration, in accordance with various embodiments.

FIG. 2B illustrates a logic die paired to a memory die, in accordance with various embodiments.

FIG. 3 illustrates an inference process of a DNN model, in accordance with various embodiments.

FIG. 4 illustrates an integrated cell, in accordance with various embodiments.

FIG. 5 illustrates an integrated cell with a RAM-multiply-adder architecture, in accordance with various embodiments.

FIG. 6 illustrates an integrated cell capable of handling different types of weights, in accordance with various embodiments.

FIG. 7 illustrates an integrated cell array with a single column, in accordance with various embodiments.

FIG. 8 illustrates an integrated cell array with multiple columns and rows, in accordance with various embodiments.

FIG. 9 illustrates time multiplexing for an exemplary matrix multiplication (MatMul) operation, in accordance with various embodiments.

FIG. 10 illustrates time multiplexing for another exemplary MatMul operation, in accordance with various embodiments.

FIG. 11A illustrates an integrated cell with a repair unit, in accordance with various embodiments.

FIG. 11B illustrates decomposing an exemplary MatMul operation, in accordance with various embodiments.

FIG. 12 illustrates decomposing another exemplary matrix multiplication operation, in accordance with various embodiments.

FIG. 13 illustrates a 3D integrated cell, in accordance with various embodiments.

FIG. 14 illustrates an integrated memory-compute system, in accordance with various embodiments.

FIG. 15 illustrates a logic unit with a multiply-add unit, in accordance with various embodiments.

FIG. 16 is a flowchart showing a method of executing a DNN, in accordance with various embodiments.

FIG. 17 illustrates an example transformer model, in accordance with various embodiments.

FIG. 18 illustrates the first inference process of a transformer model, in accordance with various embodiments.

FIG. 19 illustrates subsequent inference processes of the transformer model, in accordance with various embodiments.

FIG. 20 is a block diagram of an example computing device, in accordance with various embodiments.

### DETAILED DESCRIPTION

The last decade has witnessed a rapid rise in AI based data processing, particularly based on neural networks (also referred to as deep neural networks (DNNs)). DNNs are widely used in various domains (e.g., language processing, computer vision, speech recognition, autonomous driving, image processing, video processing, etc.) mainly due to their ability to achieve beyond human-level accuracy. A DNN typically includes a sequence of layers. A DNN layer may include one or more deep learning operations (also referred to as “neural network operations”), such as embedding operation, MatMul operation, layer normalization, batch normalization, activator operations (e.g., Sigmoid linear unit (SiLU) operation, SoftMax operation, etc.), pooling, elementwise operation, linear operation, nonlinear operation, and so on.

Neural network operations may be tensor operations. Input or output data of neural network operations may be arranged in data structures called tensors. Taking a convolutional layer for example, the input tensors include an activation tensor (also referred to as “input feature map (IFM)” or “input activation tensor”) including one or more activations (also referred to as “input elements”) and a weight tensor. The weight tensor may be a kernel (a 2D weight tensor), a filter (a 3D weight tensor), or a group of filters (a 4D weight tensor). A convolution may be performed on the input activation tensor and weight tensor to compute an output activation tensor in the convolutional layer.

A tensor is a data structure having multiple elements across one or more dimensions. Examples of tensors include vector (which is one-dimensional (1D) tensor), matrix (which is two-dimensional (2D) tensor), 3D tensors, four-dimensional (4D) tensors, and even higher dimensional tensors. A dimension of a tensor may correspond to an axis, e.g., an axis in a coordinate system. A dimension may be measured by the number of data points along the axis. The dimensions of a tensor may define the shape of the tensor. A DNN layer may receive one or more input tensors and compute an output tensor from the one or more input tensors. In some embodiments, a 3D tensor may have an X-dimension, a Y-dimension, and Z-dimension. The X-dimension of a tensor may be the horizontal dimension, the length of which may be the width of the tensor; the Y-dimension may be the vertical dimension, the length of which may be the height of the tensor; and the Z-dimension may be the channel dimension, the length of which may be the number of channels. The coordinates of the elements along a dimension may be integers in an inclusive range from 0 to (L−1), where L is the length of the tensor in the dimension. For instance, the x coordinate of the first element in a row may be 0, the x coordinate of the second element in a row may be 1, and so on. Similarly, the y coordinate of the first element in a column may be 0, the y coordinate of the second element in a column may be 1, and so on. A 4D tensor may have a fourth dimension, which may indicate the number of batches in the operation.

The deployment and execution of complex models are usually carried out on high-performance graphics processing units (GPUs). While GPUs provide the computational horsepower to handle these sophisticated models, they typically come with significant drawbacks, including high power consumption and latency issues. These limitations can be especially problematic in environments where real-time processing and power efficiency are critical, such as in mobile devices, edge computing, and Internet of Things (IoT) applications.

Currently available methodologies often employ sequential read-only memories (ROMs) in key multiply-add operational implementations, leading to flexibility issues. ROMs, by their nature, are static and lack the adaptability required for the dynamic workloads encountered in AI and machine learning tasks. This rigidity can result in inefficiencies and limit the system's ability to optimize performance for varying computational demands.

A methodology employed in the chip design involves using separate sequential ROMs that hold the data, alongside distinct multipliers and tree adders that process this data. However, this approach necessitates considerable routing between sequential ROMs, multipliers, and adders, as well as other parts of the logic fabric. Consequently, this can lead to inefficiencies due to the significant routing overhead and the latency introduced by the interconnections. Moreover, the design's flexibility is compromised as it is tailored to specific models, making it less adaptable for various AI models and applications. The lack of flexibility poses a significant challenge in optimizing performance across diverse AI workloads, ultimately impacting the system's overall efficiency and capability to handle varying model sizes and complexities. However, this disclosure can necessitate better routing due to Wafer-on-Wafer technology.

Some currently available solutions are based on General-Purpose GPUs (GPGPUs). The customary method involves using a standard GPU. In this setup, model weights are loaded from memory every time an inference task is undertaken. While GPUs provide versatility, capable of managing a broad spectrum of tasks, this flexibility results in compromises in areas like optimization, power consumption, and latency. Specifically, GPGPUs, despite having stacked memory, do not perform computations within the memory. Consequently, data frequently shuttle between the memory and the GPU compute units, leading to high-bandwidth transactions. This process is power-intensive and time-consuming, especially for complex models. Furthermore, the design of GPUs to handle a variety of tasks makes them inefficient for dedicated tasks such as inference on a pretrained model.

Some currently available solutions are compute-in-memory solutions. This cutting-edge approach combines memory and processing units within a single chip, allowing computations to be performed directly where the data resides. This architecture minimizes the need for data transfer between memory and processing units, which can greatly reduce energy consumption and latency. Unlike traditional dynamic random-access memory (DRAM), compute-in-memory solutions integrate computational units as part of the bit cell, fundamentally altering the memory array. This integration changes the memory architecture, making it distinct from conventional optimized DRAM designs.

Despite the advantages, compute-in-memory solutions face significant challenges related to the integration of memory and compute units. Traditional optimized DRAM or other memory arrays cannot be used directly because the compute-in-memory approach requires modifications to the memory array. Specifically, this involves embedding computational units such as logic gates, adders, or even more complex arithmetic units within the memory cells. This integration fundamentally changes the architecture of the memory array, invalidating many of the optimizations that have been developed for conventional memory designs.

As a result, the fabrication process is altered to accommodate these new integrated circuits. This not only complicates the design and manufacturing process but also introduces new challenges in terms of scalability and flexibility. The modified memory arrays are no longer optimized solely for memory storage and retrieval but now balance computational capabilities as well. This complexity can lead to higher costs and potential reliability issues.

Moreover, the dense integration of computational and memory units poses significant thermal management challenges. The close proximity of these units can exacerbate heat dissipation problems, impacting the overall performance and longevity of the system. New thermal management solutions and optimizations are required to address these issues, further complicating the development and deployment of compute-in-memory solutions.

Some currently available solutions are memory-in-compute solutions. This innovative approach integrates memory and processing units to perform computations directly where data is stored. This eliminates the need for extensive data movement between memory and processing units, theoretically reducing latency and energy consumption. Although memory-in-compute solutions can significantly enhance data throughput and reduce latency, they often suffer from limited scalability and flexibility. The integration of memory with compute units complicates the design and manufacturing process, leading to higher costs and potential reliability issues. Furthermore, these solutions may struggle with heat dissipation due to the dense packing of computational and memory units, which can impact overall performance and longevity.

Some currently available solutions are Neural Processing Unit (NPU)-based solutions. NPUs are specialized hardware designed explicitly for AI tasks, particularly inference on pretrained models. They are optimized for the types of computations required in deep learning, such as matrix multiplications and convolutions, and can handle large-scale model weights more efficiently than general-purpose hardware. NPUs, similar to GPUs, provide flexibility for deep learning tasks, this flexibility also comes at the expense of limitation in the model size and context input.

Some currently available solutions are based on Central Processing Units (CPUs). CPUs are also used for AI inference tasks. By loading the model on them. However, CPUs are not suitable for large-scale matrix multiplications which are essential for AI inferencing tasks. They also consume more power and are slower in comparison to dedicated solutions.

Some currently available solutions are Dedicated Accelerator solutions. Dedicated accelerators are designed specifically for AI training and inference tasks. These accelerators offer high performance and efficiency for specific AI workloads by optimizing hardware for the unique demands of deep learning computations. They can handle large-scale models and complex operations more effectively than general-purpose hardware. While dedicated accelerators provide unparalleled performance for AI tasks, they still require frequent data movement between memory and processing units, which can introduce latency and reduce overall efficiency. This need for data transfer can limit their effectiveness for tasks that require rapid and extensive memory access.

There are also AI processors solutions. These processors significantly outperform traditional edge AI processors in terms of area and power efficiency. Utilizing a unique, powerful, and scalable structure-driven dataflow architecture, AI processors take advantage of the core properties of neural networks. This enables edge devices to run deep learning applications at full scale more efficiently, effectively, and substantially than traditional solutions, while significantly lowering costs. Despite their impressive performance and efficiency, AI processors are often optimized for very small models and are not efficient for larger models where data needs to move back and forth from memory, impacting overall performance and efficiency. And they are still not real-time.

Some currently available solutions are based on Field Programmable Gate Arrays (FPGAs). FPGAs are another solution used for AI inference. They are programmable hardware that can be customized to perform specific tasks, including loading and handling large language models (LLM) weights.

While FPGAs offer flexibility, they have significantly lower performance compared to dedicated hardware solutions and are not as power-efficient and not cost effective.

Embodiments of this disclosure may improve on at least some of the challenges and issues described above by embedding a DNN on an IC device (e.g., a silicon die or chip) that includes one or more integrated cells. In an example, an integrated cell is a cell with memory, multipliers, adders that can be stitched together creating a much more efficient overall design and eliminating much of the need for huge fabrics. The memory may be RAM, such as DRAM or static random-access memory (SRAM). This approach can combine RAM, multipliers, and adders within an individual cell or a cluster of cells. Such integration can significantly reduce the need for extensive routing between separate components, optimizing space and minimizing data movement.

In various embodiments of this disclosure, a DNN model is embedded onto an IC device. The IC device may implement the model architecture and internal parameters (e.g., weights) of the DNN. The IC device may include integrated cells for performing matrix multiplication (MatMul) operations in the DNN model. Integrated cell is also referred to as “integrated memory cell,” “integrated unit,” or “processing unit” in some implementations. The integrated cells may be arranged in rows or columns. An integrated cell may include a RAM cell, one or more dot product units, multiplexers, adder, route-in unit, control unit, and vector machine. The RAM cell may store weights and activations. The RAM cell may include one or more RAM banks in a memory layer, which may be placed over a logic layer that includes the other components of the integrated cell. The dot product unit(s) may perform multiplications and accumulations using the weights with activations to compute dot products. The integrated cell may include dot product units that can handle various integer and floating-point data types. Different dot product units may perform computation for different data types. The adder may sum a dot product computed by the dot product unit(s) and a value from another integrated cell. A multiplexer may be between the adder and dot product unit(s) along a data path within the integrated cell. The route-in unit may facilitate data transfer, e.g., data transfer from the RAM cell to the dot product unit(s) or data transfer from another integrated cell to the integrated cell. The control unit may manage memory operations and detect and repair errors in memory operations. The vector machine may provide control or configuration signals to the dot product unit(s) and multiplexers to direct the flow of multiply-accumulate operations. The integrated cells may also include counters, which control weight fetching from RAM cells to the multipliers, or multiplexers, which select and distribute appropriate activations to multipliers. The integrated cells may execute a MatMul operation through multiple clock cycles. The MatMul operation may be decomposed based on sizes of the weight matrix or activation matrix and features of the integrated cell array. The integrated cells may perform a part of the MatMul operation in each clock cycle. The integrated cells may be coupled with add units.

In some embodiments, chip architectures in this disclosure may feature a vertically integrated design, where the DNN model's weights may be stored in a memory layer on the top, while the logic and processing units may reside in a logic layer on the bottom. Such chip architectures may be built on Wafer-on-Wafer (e.g., wafer bonding) technology. For instance, a memory wafer may be bonded with a logic wafer to form an integrated wafer. Memory may be placed near compute units without needing to change the memory array. Instead, a building block having both compute and memory is built, and the fabrication process can be retained. This architecture can be particularly effective for large DNNs, such as LLMs, where efficient and rapid data processing is crucial. By having multiply-add units co-located next to memory, the design can enhance performance and power efficiency.

The approach in this disclosure can provide flexibility. Using RAM instead of ROM within the integrated system can provide much better flexibility. Unlike ROM, which is fixed and cannot be modified after manufacturing, DRAM allows for dynamic data storage and retrieval, providing the ability to adapt to different computational tasks and model requirements. This flexibility can be crucial for applications involving LLMs, which often require frequent updates and adjustments to the stored data. Despite being within the same die, the use of DRAM can ensure that there is no memory wall, as the high-bandwidth, low-latency connections facilitated by through-silicon vias (TSVs) can maintain efficient data transfer between memory and compute units. This can result in a system that is both versatile and efficient, capable of meeting the demands of sophisticated deep learning models.

This approach can also provide power efficiency. The design can significantly enhance power efficiency by placing the memory close to the compute units. This proximity allows the processing to be spread out and operate at relatively low frequencies (500 MHz). In contrast to traditional GPU designs, which require high speeds to compensate for the data transfer between memory and compute units, the approach in this disclosure can minimize the need for such extensive data movement. By reducing the frequency of operation, it can keep the power consumption low while maintaining high performance, making this solution ideal for power-sensitive applications.

This approach can further provide scalability. One of the significant challenges in deploying efficient computation models is the physical space constraints and routing complexities on a silicon chip. This disclosure addresses this by wafer bonding DRAM directly on top of a logic wafer, creating a vertically integrated chip stack. Each stack may include high-density memory on the top and specialized compute logic on the bottom, connected by TSVs. This 3D integration can eliminate the need for extensive routing between separate components, thereby saving space and reducing data movement. The modular nature of the chip stacks allows for scalable and flexible deployment, adapting to various computational needs and future technological advancements. By co-locating memory and compute within a single structure, the design optimizes performance and efficiency, making it ideal for accelerating operations in LLMs such as transformers.

This approach can also provide real-time computing. The power efficiency and performance improvements provided by the approach in this disclosure can make it ideal for edge computing, mobile, and IoT applications where resources are limited and low latency is crucial. By integrating memory and compute logic within a single 3D structure, the approach in this disclosure can eliminate the need for extensive routing and significantly reduce data movement. This tightly integrated design can support real-time computing requirements more effectively, ensuring rapid and efficient processing of computational tasks. As a result, this solution is highly suitable for time-sensitive applications, delivering quick and reliable performance in resource-constrained environments.

For purposes of explanation, specific numbers, materials and configurations are set forth in order to provide a thorough understanding of the illustrative implementations. However, it can be apparent to one skilled in the art that the present disclosure may be practiced without the specific details or/and that the present disclosure may be practiced with only some of the described aspects. In other instances, well known features are omitted or simplified in order not to obscure the illustrative implementations.

Further, references are made to the accompanying drawings that form a part hereof, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations are described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, device, or DNN accelerator that comprises a list of elements is not necessarily limited to only those elements but may include other elements not expressly listed or inherent to such method, process, device, or DNN accelerators. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description below and the accompanying drawings.

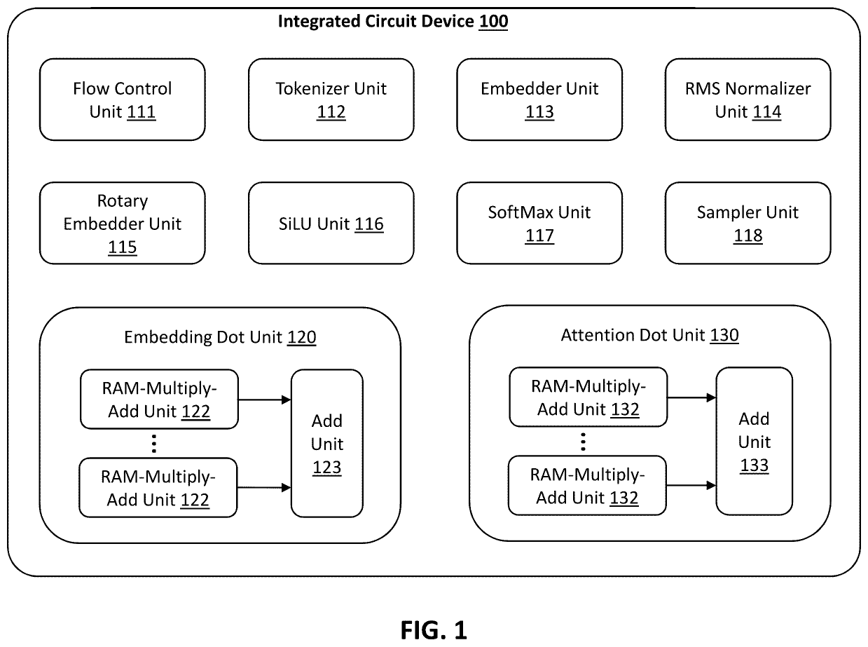

FIG. 1 illustrates an IC device 100 that implements a model on silicon, in accordance with various embodiments. In some embodiments, the IC device 100 may be a hardware implementation of a DNN, such as a transformer-based model. An example of the DNN is an LLM. At least part of the model architecture, weights, and flow of the DNN can be embedded into the IC device 100. For instance, the IC device 100 may include memories that store the weights of the DNN. The IC device 100 may also include compute units that are mapped to the operators in the DNN. In some embodiments, the IC device 100 may be a chip, such as a silicon chip.

As shown in FIG. 1, the IC device 100 includes a flow control unit 111, tokenizer unit 112, embedder unit 113, root mean square (RMS) normalizer unit 114, rotary embedder unit 115, SiLU unit 116, SoftMax unit 117, sampler unit 118, embedding dot unit 120, and attention dot unit 130. A unit in the IC device 100 may be a circuit or may include multiple circuits. In other embodiments, the IC device 100 may include fewer, more, or different components. For example, the base die 110 may include more than one flow control unit 111, tokenizer unit 112, embedder unit 113, RMS normalizer unit 114, rotary embedder unit 115, SiLU unit 116, SoftMax unit 117, sampler unit 118, embedding dot unit 120, or attention dot unit 130. As another example, the units may be arranged in fewer, more, or different dies of the IC device 100. Further, functionality attributed to a component of IC device 100 may be accomplished by a different component included in the IC device 100 or a different device.

The flow control unit 111 manages data flow between various components of the IC device 100. In some embodiments, the flow control unit 111 plays a role in orchestrating various components (e.g., units) of the IC device 100 to execute operations according to a predetermined timing sequence. The flow control unit 111 may also be referred to as a sequencer unit, which can orchestrate one or more other components of the IC device 100 according to a predetermined timing sequence of the DNN. In an example, the flow control unit 111 may control and ensure that the tokenizer unit 112 converts input tokens and passes them to the embedding sections, such as the embedder unit 113, the rotary embedder unit 115, and embedding dot unit 120; the embeddings are then processed and passed to the attention dot unit 130 for attention computation; the attention results are then normalized by the RMS normalizer unit 114, activated by the SiLU unit 116, and passed through the SoftMax unit 117 to generate output probabilities; finally, the sampler unit 118 samples from the output distribution and generates the final output tokens.

In some embodiments, the DNN operates in a feedforward manner. In an example, the DNN may include a sequence of layers. A layer may have one or more operators. For a layer having multiple operators, the operators may be arranged in the sequence. Each operator may correspond to a neural network operation. For example, a MatMul operator specifies a MatMul operation. The sequence of all the operators in the DNN may be predetermined as a part of the model architecture of the DNN. In some embodiments, the spatial shape of the input tensor(s) and output tensor of an operator can also be predetermined. During inference, data flows through the operators in the DNN in the predetermined sequence. The predetermined sequence of the operators in the DNN can be mapped into a timing sequence of various components of the IC device 100 executing the corresponding neural network operations. The timing sequence of neural network operations may include stages of operations, one following another. In a particular time slot or stage in the timing sequence, data can be moved in, processed, and moved out to be processed in the next/following time slot, in a feedforward, progressive manner.

In some embodiments, the flow control unit 111 may implement digital logic to generate clock edges/signals (e.g., control signals, timing signals, enable signals, disable signals, trigger signals, etc.) to orchestrate operations to be performed according to the timing sequence. The flow control unit 111 may control data flow into or out of one or more other components of the IC device 100. The flow control unit 111 may also enable or disable one or more other components of the IC device 100 according to a predetermined timing sequence.

The tokenizer unit 112 is a hardware implementation of a tokenizer in the DNN. In an example, the tokenizer unit 112 is a hardware-based tokenizer for a DNN. The tokenizer unit 112 may convert raw data (e.g., words) to tokens. For instance, the tokenizer unit 112 may use the DNN's vocabulary to convert words received from a user to tokens that can be further processed by other operators in the DNN. The vocabulary may be predefined vocabulary. In some embodiments, the vocabulary of the DNN is implemented on the tokenizer unit 112. For instance, the vocabulary may be stored in a data storage unit of the tokenizer unit 112. The tokenizer unit 112, after receiving words, may compare the words with the vocabulary to determine indices of tokens corresponding to the words. The tokenizer unit 112 may output the token indices.

In some embodiments, the tokenizer unit 112 includes a cycle buffer, comparator, memory, ID block, and multiplexer (MUX). The cycle buffer may receive and store data received by the tokenizer unit 112. The data may be the input data of the DNN. The input data may be one or more words that need to be tokenized. In some embodiments, the tokenizer unit 112 may have a different type of data storage unit from the cycle buffer for storing input data. The comparator retrieves input data from the cycle buffer and compares the word(s) with the vocabulary of the DNN. The vocabulary of the DNN is stored in the memory. The memory may store a list of vocabulary entries, which are predefined words or tokens. Each vocabulary entry corresponds to a unique Token ID. The ID block stores the Token IDs associated with each vocabulary entry. When the comparator finds a match in the vocabulary, the ID block receives the corresponding Token ID. After a Token ID is retrieved, it is output through the ID block. The comparator may access the vocabulary in the memory to find a match for each word in the input data. When a match is found, the corresponding Token ID is fetched from the ID block and provided to the MUX. The MUX may output the Token ID as an output of the tokenizer unit 112. In some embodiments, the output of the Token ID from the MUX may be controlled by a signal from the comparator. The signal may indicate that a match has been found.

The embedder unit 113 may implement an embedder (e.g., an embedding layer) of the DNN. The embedder unit 113 may execute the embedding layer to convert tokens (such as tokens generated by and received from the tokenizer unit 112) to embedding vectors. In some embodiments, the embedder unit 113 may include look-up tables that map tokens to embedding elements. The look-up tables may output embedding elements corresponding to input tokens. The embedding elements may constitute the embedding vector of the input tokens.

In an example, the embedder unit 113 includes 256 look-up tables. The look-up tables may have the same storage size, e.g., 1000 KB. Each of the look-up tables may have 112,000 lines. In some embodiments, the look-up tables may be implemented on one or more RAMs or ROMs. In an example, the 256 look-up tables are implemented on 256 RAMs, respectively. The embedder unit 113 may receive an input token. In the example shown in FIG. 1, the embedder unit 113 receives an input token represented by 15 bits. The input token may have an integer format. The embedder unit 113 may also receive control signals. For instance, the embedder unit 113 receives an embedder cycle signal, which may have 10 bits. The embedder unit 113 also receives an embedder run signal, which may have 1 bit. The embedder unit 113 may also receive an embedder on/off signal, which may have 1 bit.

The output of the embedder unit 113 may be an embedding vector. For instance, the embedder unit 113 may produce an embedding vector with floating-point (e.g., FP16) data elements. The dimension of the embedding vector may indicate the total number of data elements in the embedding vector. In an example, the dimension of the embedding vector may be 10,096. In some embodiments, the embedder unit 113 may receive 32,000 tokens. The total embedder size may be 250 MB, which equals 10,096×32,000×2B. Each of the tokens in the vocabulary may be broken into 16 chunks of 256 numbers. In some embodiments (e.g., embodiments where the look-up tables are stored in RAMs), the first out of 16 numbers may be read from the table. Reading from the RAM may be sequential for 16 cycles, so the next line is to be pre-charged but it may be unnecessary to pre-charge other lines. Within each cycle, the 256 look-up tables may output 256 embedding vector elements, respectively. The embedder unit 113 may return 256 elements every clock cycle for 16 clocks cycles. After finishing the 16 cycles, the embedder unit 113 may be idle for about 10,000 cycles. Power gating may be used.

The RMS normalizer unit 114 may normalize data using RMS normalization. The RMS normalizer unit 114 may implement one or more RMS normalizer functions in the DNN. An RMS normalizer function may be denoted as:

$$\frac{{x}_{i} \cdot {W}_{R M {S}_{i}}}{\sqrt{\frac{{\sum }_{j = 0}^{4 , 096} {x}_{j}^{2}}{4 , 096} + 1 {0}^{- 5}}}$$

In some embodiments, the RMS normalizer unit 114 may receive an input vector (e.g., 4096 FP16 elements) and return an RMS-normalized vector (e.g., 4096 elements in FP8 format). The RMS normalizer unit 114 may receive 256 elements every clock for 16 clocks cycles. The RMS normalizer unit 114 may include tree adder 1502 to add a number of values (e.g., 256 values) together simultaneously. The RMS normalizer unit 114 may include a look-up table comprising one or more precomputed values of the function:

$$f ( x ) = {\sqrt{\frac{x}{4 , 096} + 1 {0}^{- 5}}}^{- 1} .$$

The rotary embedder unit 115 may apply rotary positional embeddings on input data. The rotary embedder unit 115 is the hardware implementation of one or more rotary position encoders in the DNN. The rotary embedder unit 115 may produce rotary positional encoded embeddings. In some embodiments, the rotary embedder unit 115 may provide the functionality of a sine cosine unit without the need to calculate/compute sine and cosine in real-time. The rotary embedder unit 115 may have a sine cosine unit that has a look-up table implementation. In some embodiments, the rotary embedder unit 115 may include a look-up table comprising one or more precomputed values of a cosine function (e.g.,

$$f ( t ) = cos ( {10}^{- \frac{{h}_{n}}{16}} \cdot t ) ) .$$

The rotary embedder unit 115 may include another look-up table comprising one or more precomputed values of sine function (e.g.,

$$f ( t ) = sin ( {10}^{- \frac{{h}_{n}}{16}} \cdot t ) ) .$$

The SiLU unit 116 is a hardware implementation of one or more SiLU activators in the DNN. The SiLU unit 116 may include a look-up table having one or more precomputed values of a SiLU function:

$$f ( x ) = \frac{x}{1 + {e}^{- x}}$$

In some cases, the SiLU unit 116 includes a MUX controller and a MUX. The MUX controller may check whether the input value meets a particular condition and selects a particular value to use as the output of SiLU unit 116. The MUX controller may output a 2-bit value as selection signal for the MUX, to select one of three possible values to use as the output. For example, when the sign bit is 0 and the most-significant bits (MSBs) of the input are “11”, the input is selected by the MUX and passed on to use as the output. When the sign bit is 1 and the MSBs of the input are “11”, the value of “0” is selected by the MUX to use as the output. Otherwise, the value from the look-up table is used as the output.

The SoftMax unit 117 is a hardware implementation of one or more SoftMax activators in the DNN. The SoftMax unit 117 may implement a SoftMax function for output probability distribution. In some embodiments, the SoftMax unit 117 may execute a SoftMax function using one or more look-up tables that are pre-configured with precomputed data. The SoftMax function may be:

$$\frac{{e}^{\frac{{x}_{i} - {x}_{max}}{\sqrt{128}}}}{{\sum }_{j = 0}^{t} {e}^{\frac{{x}_{j} - {x}_{max}}{\sqrt{128}}}}$$

In some embodiments, the SoftMax unit 117 includes look-up table implementation of the SoftMax function instead of a compute-oriented solution. In some embodiments, the SoftMax unit 117 receives an input vector of t FP16 elements (1<t<512) and returns the SoftMax normalized vector of the same size. The SoftMax unit 117 receives 16 numbers per cycle for up to 32 cycles and returns 16 numbers per cycle for up to 32 cycles.

In an example, the SoftMax unit 117 receives an input vector including 16 elements, each of which is a FP16 value, in a clock cycle. The total number of bits of the input vector is 256. The SoftMax unit 117 may also receive a compare control signal, normalize control signal, exponent control signal, multiply control signal, on/off control signal, other types of control signals, or some combination thereof. A control signal may have 1 bit. The output of the SoftMax unit 117 may be 16 elements with UFP16 format. The total number bits may be 240. The SoftMax unit 117 may execute the SoftMax function using 16 clock cycles. Numbers may be stored in a first-in-first-out (FIFO) buffer while they are compared to find the largest number in the vector. The FIFO buffer may output numbers. The largest number may be subtracted. The subtraction result is provided to a look-up table. The output of the look-up table enters a second FIFO. Numbers may be pulled out of the second FIFO and multiplied by the normalization value. It may take a total of 24 cycles to compute the output. The 24 cycles may include 8 latency cycles and 16 piping cycles

In some embodiments, the SoftMax unit 117 may be included in the attention dot unit 131 to perform SoftMax on an input vector (e.g., FP16 vector) and to output a vector (e.g., FP16 vector). The SoftMax unit 117 may include a look-up table comprising one or more precomputed values of an exponent function:

$$f ( x ) = {e}^{\frac{x}{\sqrt{128}}} .$$

The SoftMax unit 117 may include another look-up table comprising one or more precomputed values of a reciprocal function:

$$f ( x ) = \frac{1}{x} .$$

The SoftMax unit 117 may include a tree adder that can add a number of values (e.g., 18 values) together simultaneously.

The sampler unit 118 is a hardware implementation of one or more samplers in the DNN. The sampler unit 118 may sample from the output distribution. In some embodiments, the sampler unit 118 may receive an input vector and compare elements of the input vector to find the largest value. The sampler unit 118 may determine the index of the largest number and return a token. In some embodiments, the sampler unit 118 may receive a logits vector. In an example, the vector may include 32,000 elements. In some embodiments, the sampler unit 118 may receive 256 input elements for a cycle and may take 125 cycles to process the 32,000. The input elements may be in FP16 format. The total number of bits for the 256 input elements may be 4,096 bits. In some embodiments, the 256 input elements may be received from 256 MatMul units, such as 256 attention dot units, respectively. In some embodiments, the sampler unit 118 may implement a deterministic sampler having zero temperature. The sampler unit 118 may also receive control signals, such as an on/off signal indicating whether the sampler unit 118 is to be on or off, a restart signal indicating whether to restart the sampler unit 118, and a run signal. A control signal may have 1 bit. The sampler unit 118 may determine an index, such as a 32-bit index, corresponding to the largest number in the input vector. The index may correspond to an output token. In some embodiments, the output token may be a 15-bit integer.

In some embodiments, the sampler unit 118 includes 256 sampling comparators. In other embodiments, the sampler unit 118 may include a different number of sampling comparators. With the 256 sampling comparators, the sampler unit 118 can compare 256 input elements every clock cycle and keeps the index and value of the largest number. Each sampling comparator may compare two logits or values in a single clock cycle and return the larger number of its index (token). Each value may have 16 bits and may be in the FP16 format. The index(token) may be a 15-bit integer. The output may include the larger value as well as the index of the larger value. In a situation where more than one number has the largest value, the sampler unit 118 may return the token with the lowest index out of the equal tokens. When finishing the 125 clock cycles, the sampler unit 118 returns the token of the largest value in the input vector. For instance, the sampler unit 118 may output the index of the largest value in the input vector.

In some embodiments, the sampler unit 118 may have sampling comparators arranged in a tree or hierarchical structure to efficiently compare a large number of values (e.g., hundreds or thousands of values or more) simultaneously. For instance, each comparator in the first tier may compare two values in the input vector and select the larger value, each comparator in the second tier may compare two values from two comparators, respectively, in the first tier, each comparator in the third tier may compare two values from two comparators, respectively, in the second tier, and so on. The last tier may include a comparator that outputs the largest value of the input vector. In some embodiments, the sampler unit 118 may have a latency of 9 clock cycles. Every layer of comparators may be pipeline. In some embodiments, the sampler unit 118 may have power gating.

The embedding dot unit 120 is hardware implementation of embedding computations in the DNN. For instance, the embedding dot unit 120 may implement MatMul operators and add operators in the DNN, such as the MatMul operators and add operators in one or more encoders of the DNN. The embedding dot unit 120 may handle the initial embedding of tokens, performing matrix multiplications to transform input data into a suitable format for the DNN.

The embedding dot unit 120 may convert input tokens into dense vector representations, which may be essential for subsequent processing in the DNN. In some embodiments, the embedding dot unit 120 are compute-in-memory units, which hold the static weights of the DNN. The static weights may be weights that do not change during inference of the DNN. The embedding dot unit 121 includes a plurality of RAM-multiply-add units 122 (individually referred to as “RAM-multiply-add unit 122”) and an add unit 123. RAM-multiply-add units may also be referred to as RAM-Mul-add units or RAMULADD units. This RAM-based design can ensure efficient storage and quick access to static weights, enhancing the speed and efficiency of embedding operations.

In some embodiments, each RAM-multiply-add unit 122 may be an integrated cell in which a RAM cell, multipliers, and at least one adder (also referred to as “add unit”) are integrated. In some embodiments, the RAM-multiply-add units 122 may perform MatMul operations. A MatMul operation may be performed on a weight tensor and an activation tensor. The activation tensor may be the output of the previous operators in the DNN. Weight tensors used by the RAM-multiply-add units 122 may be stored in the RAM banks of the RAM-multiply-add units 122.

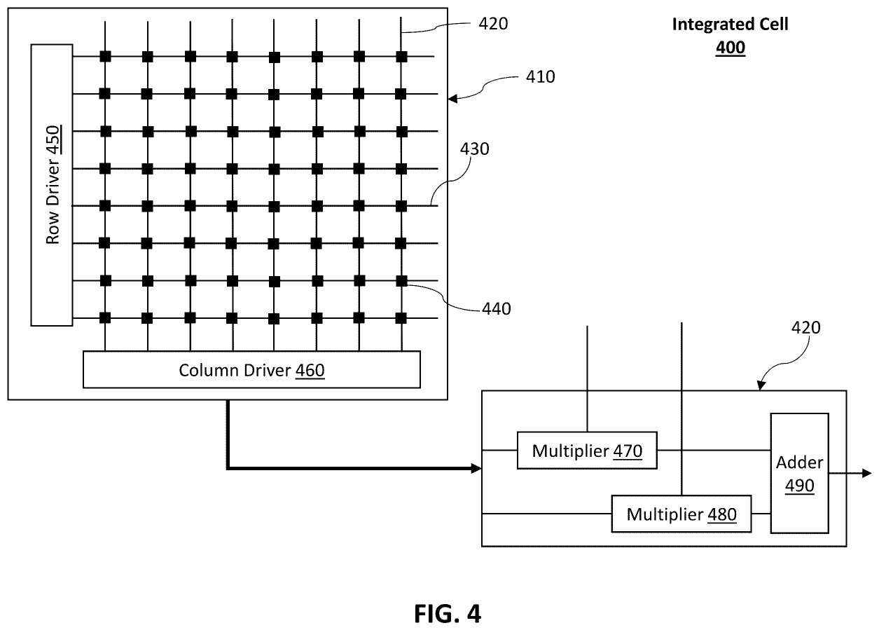

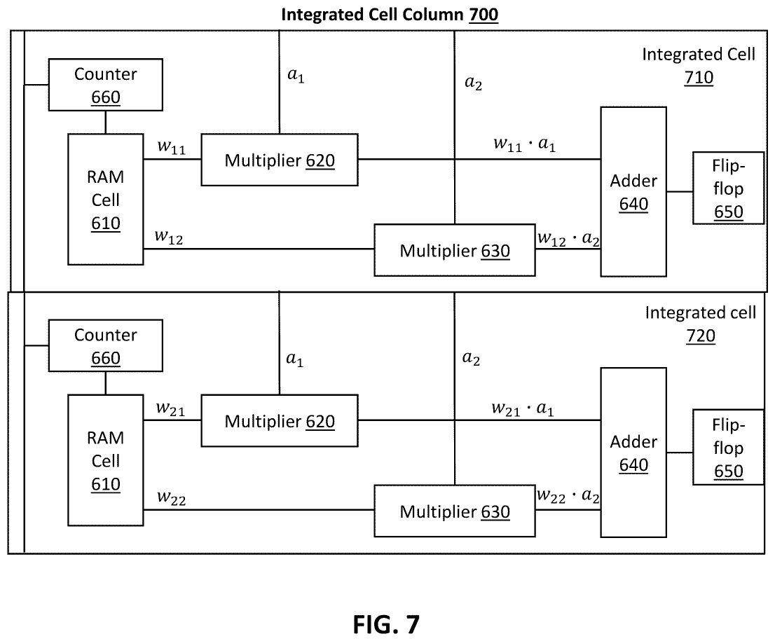

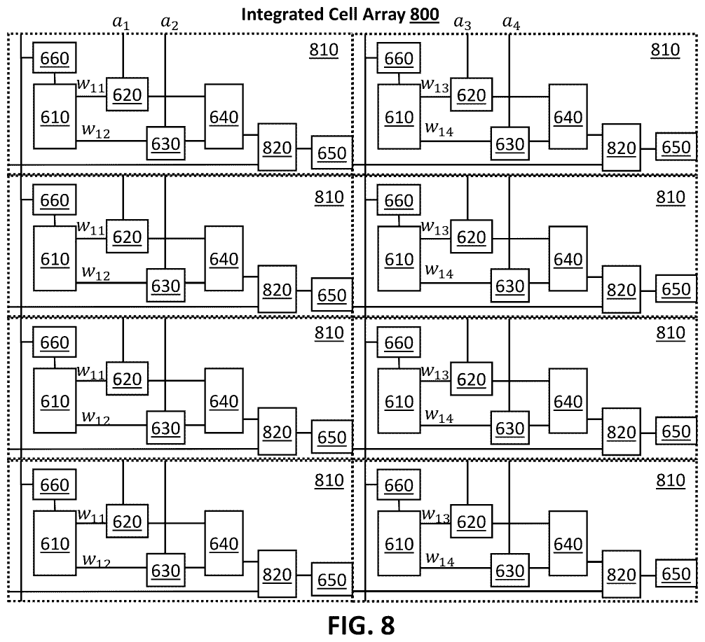

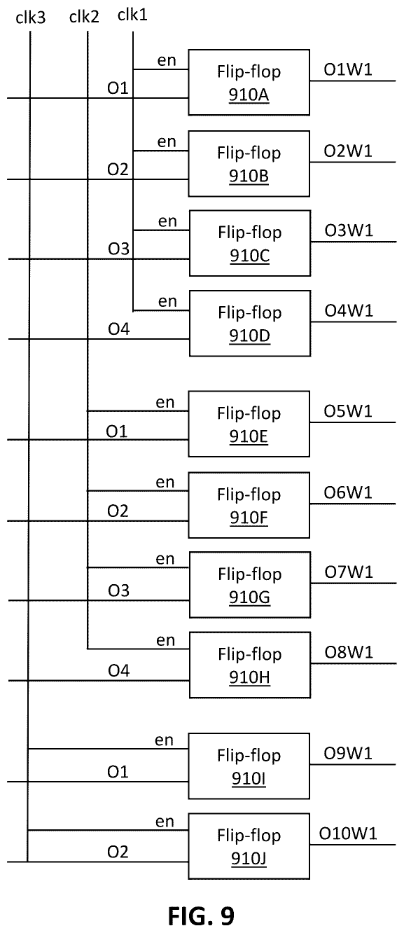

In some embodiments, the embedding dot unit 120 may include one or more integrated cell arrays. An integrated cell array include integrated cells arranged in column(s) and row(s). in some embodiments, an integrated array in the embedding dot unit 120 may be designed for certain MatMul operations in the DNN so that the efficiency of the embedding dot unit 120 may be optimized for these MatMul operations. For instance, the number of integrated cells or the layout of the integrated cell array may match or be optimal for matrix sizes of the MatMul operations. Examples of matrix sizes include sizes of weight matrices, sizes of activation matrices, or sizes of output matrices. The integrated cell array can perform other MatMul operations that have different matrix sizes. For instance, a MatMul operation having unoptimized matrix sizes may be converted by adding one or more multiplication or addition operations. The MatMul operation (or the converted MatMul operation) may be decomposed so that the execution of the MatMul operation may be performed by the integrated cell array through multiple clock cycles. The clock cycles may be controlled or orchestrated by the flow control unit 111. The flow control unit 111 may generate and provide control signals for controlling counters or multiplexers (MUXs) in integrated cells so that appropriate activations and weights are distributed to the integrated cells. Certain aspects of integrated cells are described below in conjunction with FIGS. 4-6. Certain aspects of integrated cell arrays are described below in conjunction with FIG. 7 and FIG. 8. Certain aspects of decomposing MatMul operations for distributing workload to integrated cells are described below in conjunction with FIGS. 9-12.

The attention dot unit 130 is hardware implementation of attention computations in the DNN. For instance, the attention dot unit 130 may implement MatMul operators and add operators in the DNN, such as the MatMul operators and add operators in one or more decoders of the DNN. The attention mechanism may be critical for understanding the relationships between different parts of the input sequence. The attention dot unit 130 may focus on the computation of attention scores and the weighted sum of value vectors, which may be critical for capturing dependencies and relationships between different parts of the input data. The attention dot unit 130 may be compute-in-memory dies. The attention dot unit 130 may utilize RAM to handle the dynamic nature of attention computations. This RAM-based design can allow for fast and efficient computation of attention scores, leveraging high memory bandwidth and low latency to optimize performance.

As shown in FIG. 1, the attention dot unit 131 includes a plurality of RAM-multiply-add units 132 (individually referred to as “RAM-multiply-add unit 132”) and an add unit 133. In some embodiments, each RAM-multiply-add unit 132 may include one or more multipliers, RAMs, and tree adders. In one implementation, a RAM-multiply-add unit 132 may carry out a (128—elements) dot product operation between FP16 input vector and FP16 K or V vector cached in one or more RAMs, e.g., every cycle. The dot product operation can be performed using the one or more multipliers and one or more tree adders in the RAM-multiply-add unit 132. A multiplier may multiple two values, such as two floating-point values. In an example, the attention dot unit 131 one or more FP16/FP16 multipliers. A multiplier may be specifically designed to perform multiplication of data having predetermined representations (e.g., FP4, FP6, FP8, FP12, FP16, INT8, etc.). One or more multipliers in the attention dot unit 131 may receive data from one or more RAMs. One or more tree adders may add multiplication results produced by one or more multipliers together.

The RAMs can store and provide data to one or more circuits performing logic operations in the RAM-multiply-add units 132. In some embodiments, a RAM-multiply-add unit 132 may receive an input number and multiplies it by a number from the RAM of the RAM-multiply-add unit 132 in every clock cycle. In some embodiments, a RAM may be a sequential read/write memory, such as a sequential read/write SRAM. A sequential read/write memory can be used with or in an attention dot unit to supply weights to a multiplier in the RAM-multiply-add unit 132. A RAM that can be read sequentially or written sequentially may have drastically simplified logic and circuitry for reads or writes. The RAM may be used in a special configuration where it is not dynamically readable but is built up sequentially to reduce power and area.

In some embodiments, a RAM of a RAM-multiply-add unit 132 may be placed in proximity to the circuits performing logic operations in the RAM-multiply-add unit 132. The RAM may store intermediate values of the DNN. The intermediate values may be dynamic during the DNN inference, meaning their values may change. For instance, the RAM may store a key-value (KV) cache. New keys or values may be written into the RAM as they are generated. The RAM may be referred to as KV RAM. In embodiments where the RAM is a SRAM, it may be referred to as a KV SRAM. KV RAM can enable storing the attention history (e.g., cached keys and values) of a transformer block. In an exemplary implementation, 64 SRAMs may be used to store the 32 layers and K vs. V separately, so the SRAM can read lines sequentially. The tree adders in the RAM-multiply-add units 132 may add multiplication results produced by the multipliers together. A tree adder may also be referred to as an adder tree and may include adders arranged in a tree structure. The add unit 133 may add outputs of the RAM-multiply-add units 132.

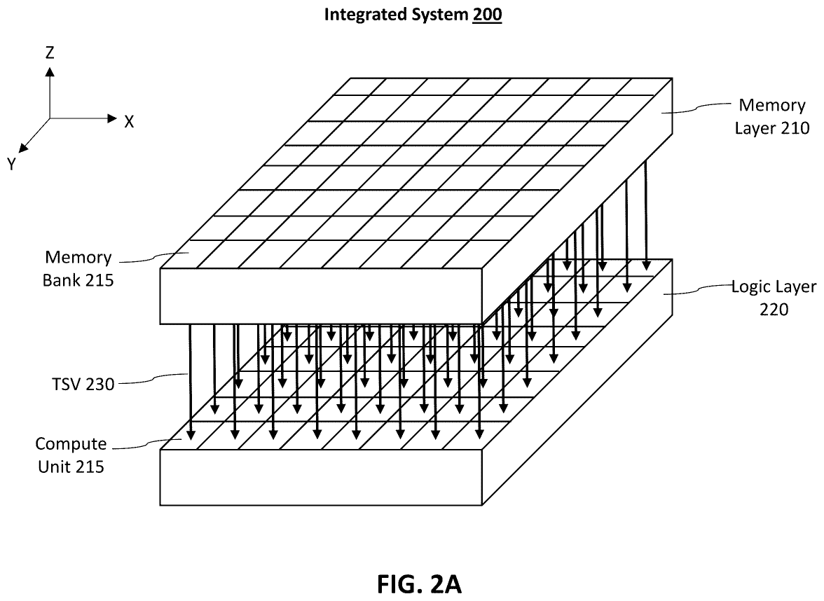

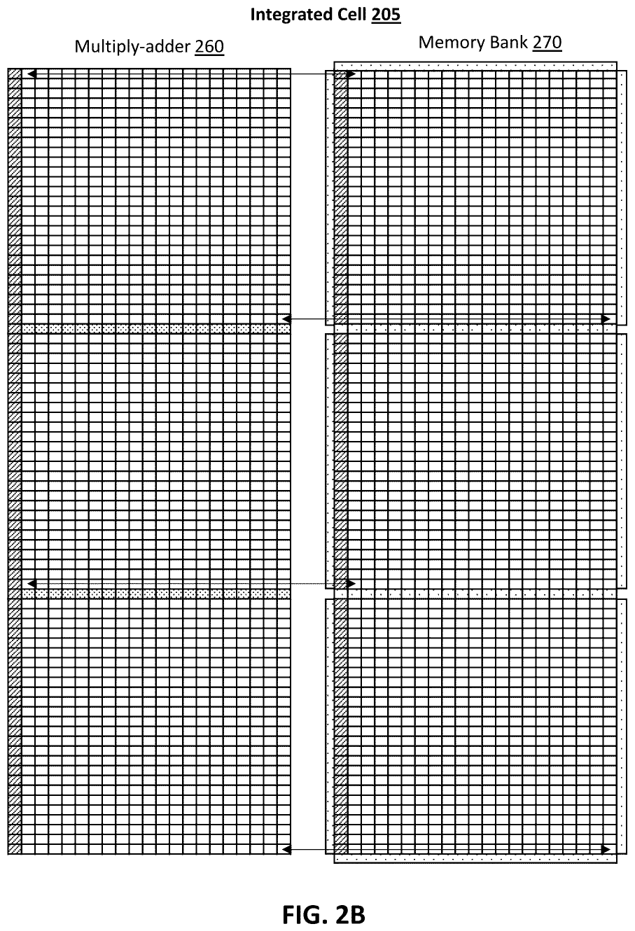

FIG. 2A illustrates 3D memory and logic integration, in accordance with various embodiments. For the purpose of illustration, FIG. 2A shows an integrated system 200 with a memory layer 210 and a logic layer 220. The integrate system 200 may be an IC device that implements one or more DNN models, such as the IC device 100 in FIG. 1. FIG. 2A also shows x, y, and z axes that are orthogonal to each other. The memory layer 210 or logic layer 220 may be in an x-y plane. The memory layer 210 is over the logic layer 220 along the z axis. Each memory bank 215 is electrically connected to a compute unit 225 through a TSV 230. In other embodiments, the integrated system 200 may include fewer, more, or different components. For instance, the integrated system 200 may include multiple memory layers.

The integrated system 200 may implement a DNN model. The memory layer 210 may store the model's weights, which may be crucial for the functioning of DNNs, particularly for LLMs that require substantial storage for their parameters. The memory layer 210 includes memory banks 215 (individually referred to as “memory bank 215”). A memory bank 215 may be a DRAM or SRAM bank. The logic layer 220 may include processing units and the architecture that can execute the logic of the DNN model, including computations and data flow management. The logic layer 220 includes compute units 225 (individually referred to as “compute unit 225”). A compute unit 225 may include multipliers and at least one adder. In some embodiments, each compute unit 225 is a multiplier-adder unit. A memory bank 215 and the corresponding compute unit 225 may constitute a RAM multiply-adder. In some embodiments, the memory layer 210 may be a memory wafer. The logic layer 220 may be a logic wafer.

The integrated system 200 may be a specialized chip that can optimize the performance and efficiency of DNNs, including large DNNs, such as LLMs.

This vertical integration of memory and logic offers several advantages. By placing the model's weights directly above the processing units, the design minimizes the distance data needs to travel, thereby reducing latency and improving overall computational efficiency. This is especially beneficial for LLMs, which demand high-speed access to large volumes of data. Additionally, this architecture can significantly reduce power consumption compared to traditional designs where memory and logic are separated, making it a more energy-efficient solution for deploying large-scale AI models. Furthermore, the RMS normalizer 310 can be loaded with sequential data, allowing the system to read the next line in memory for every clock cycle without needing an address. This sequential access can minimize the overhead associated with address generation, thus speeding up data retrieval and further enhancing the efficiency of the processing units. The logic/compute can be custom designed around the RAMs, as opposed to currently available architectures that design the RAMs around the compute. The model weights may be converted to optimize them to sit in the right place in memory, rather than making the hardware accommodate a flat sequential RAM.

FIG. 2B illustrates a logic die 260 paired to a memory die 270, in accordance with various embodiments. The logic die 260 may be an example of the logic layer 220. The memory die 270 may be an example of the memory layer 210. In some embodiments, the layout of the logic die 260 and memory die 270 may be meticulously organized to maximize computational efficiency and throughput.

For the purpose of illustration, the logic die 260 is represented by a grid with an array of partitions, each of which represents a multiply-adder. These partitions are systematically arranged in a dense matrix to ensure optimal data access and processing speed. Each partition is represented by a small, blank box in FIG. 2B. The grid representing the logic die 260 is segmented into blocks with the multiply-add partitions, shown by a dotted pattern, forming the core computational units. These units may execute essential operations like multiplication and addition, which are fundamental to the computations in models such as LLMs. The layout can ensure that each multiply-add unit is in close proximity to the neighboring units, facilitating rapid data exchange and minimizing latency. Interspersed within the grid are 40 fabric partitions, which serve as connective tissue within the architecture. These fabric partitions can provide critical interconnects and routing paths that enable efficient communication between the multiply-add units. The leftmost column of the grid, marked with diagonal stripes, represents the control and interface logic that orchestrates the operations across the entire grid. This includes managing data flow, synchronizing operations, and interfacing with external components through the PCI interface. The layout of the logic die 260 can provide a balanced and highly efficient computational environment, capable of supporting the intensive demands of modern LLM.

The memory die 270 is also represented by a grid consisting of an array of partitions, each of which represent a micro-bank with a fixed memory capacity, such as 2 MB. Each partition is represented by a small, blank box in FIG. 2B. The memory die 270 also includes scribe lines, which are represented by a dotted pattern. The scribe lines may partition the memory die 270 into three memory banks, each of which has an array of micro-banks. The leftmost column of the grid, marked with diagonal stripes, represents a power system.

The multiply-add partition of the logic die 260 may be tied to the micro-banks in the memory die 270. Pairing one memory bank to one multiply-adder. This design allows for scalable data flow and ensures that the system can handle large-scale computations without bottlenecks. The integration of multiply-add partitions with strategically placed fabric partitions ensures that the system can scale effectively while maintaining high performance and low latency.

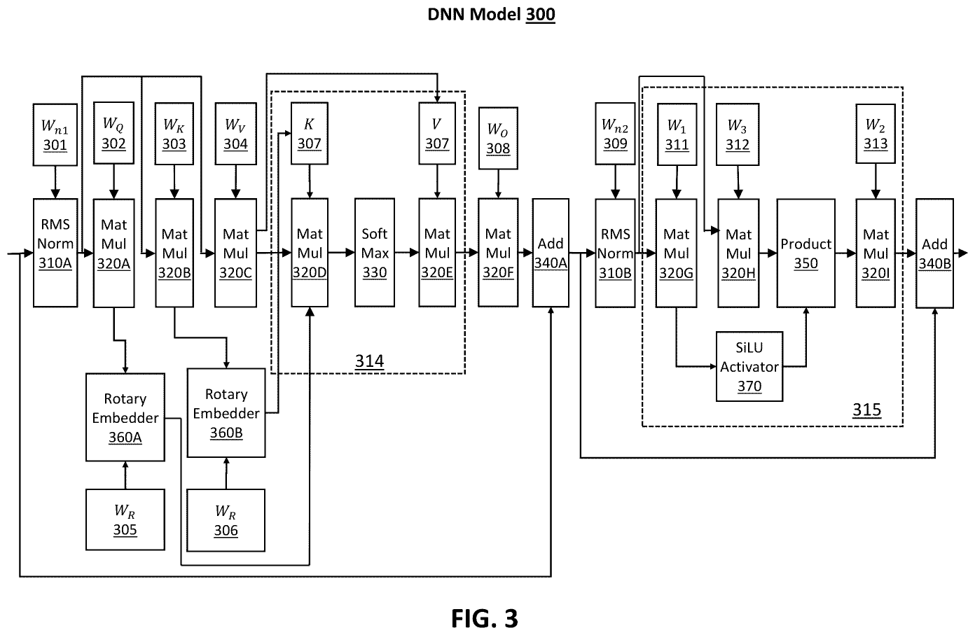

FIG. 3 illustrates an inference process of a DNN model 300, in accordance with various embodiments. In the embodiment of FIG. 3, the DNN model 300 is a transformer-based model. For instance, the DNN model 300 may be a LLM, speech recognition model, vision transformer model, and so on. The DNN model 300 may process input embeddings through a series of highly optimized neural network operations to generate output. The DNN MODEL 300 may be embedded on an IC device, such as the IC device 100 in FIG. 1. For instance, the weights of the DNN model 300 may be stored in memories of the IC device 100, and operators in the DNN model 300 may be mapped to compute units of the IC device 100.

As shown in FIG. 3, the DNN model 300 includes RMS normalizers 310A and 310B, MatMul operators 320A-320I, SoftMax activator 330, add operators 340A and 340B, product operator 350, rotary embedders 360A and 360B, and SiLU activator 370. These operators are arranged in a sequence as shown in FIG. 3. The sequence may indicate a timing sequence of the operators during the inference process. For the purpose of illustration, RMS normalizer is shown as “RMS norm” in FIG. 3, MatMul operator is shown as “MatMul” in FIG. 3, SoftMax activator is shown as “SoftMax” in FIG. 3, add operator is shown as “add” in FIG. 3, and product operator is shown as “product” in FIG. 3. In other embodiments, the DNN model 300 may include fewer, more, or different components. Also, the arrangement of the components in the DNN model 300 may be different.

The RMS normalizer 310A can standardize input data, such as input embeddings. The RMS normalizer 310A may perform an RMS normalization on an input to the DNN model 300 using a weight vector 301. In an example, the spatial size of the weight vector 301 may be 4, meaning the weight vector 301 includes 4 data elements in it. The RMS normalization may be denoted as

$$y = \frac{{x}_{i} \cdot {W}_{{RMS}_{i}}}{\sqrt{\frac{{\sum }_{j = 0}^{4 , 096} {x}_{j}^{2}}{4 , 096} + {10}^{- 5}}} ,$$

where i and j are indices, x is the input, W_{RMS} is the weight (which may be referred to as RMS attention weights), and y is the output. The weight vector 301 may also denoted as Wₙ₁. The RMS normalization can normalize input data elements of the DNN model 300 based on the RMS of the activations. The normalization may stabilize the inputs and ensure that the attention weights can be computed on approximately scaled inputs, leading to better training stability and faster convergence. The output of the RMS normalizer 310A may be one or more tokens. In an example, the token may be represented by a 15-bit integer. The output of the RMS normalizer 310A is a vector. In an example, the dimension of the vector is 4.

At least some of the MatMul operators 320A-320F can handle the transformation and integration of embedding vectors across different layers. As shown in FIG. 3, the output of the RMS normalizer 310A is provided to the MatMul operator 320A. The MatMul operator 320A performs MatMul on the output of the RMS normalizer 310A and a weight matrix 302. The weight matrix 302 may be a matrix of query weights, which may be denoted as W_{Q}. The MatMul result is provided to the MatMul operator 320B. The output of the RMS normalizer 310A is also provided to the MatMul operator 320B. The MatMul operator 320B performs MatMul on the output of the RMS normalizer 310A and a weight matrix 303. The weight matrix 303 may be a matrix of key weights, which may be denoted as W_{K}. The output of the RMS normalizer 310A is also provided to the MatMul operator 320C. The MatMul operator 320C performs MatMul on the output of the RMS normalizer 310A and a weight matrix 304. The weight matrix 304 may be a matrix of value weights, which may be denoted as W_{V}. The MatMul result of the MatMul operator 320A, MatMul operator 320B, or MatMul operator 320C may be a vector. In an example, the spatial size of the weight matrix 302, weight matrix 303, or weight matrix 304 is 4×4; and the dimension of the vector computed by the MatMul operator 320A, MatMul operator 320B, or MatMul operator 320C is 4.

The MatMul result computed by the MatMul operator 320A is provided to the rotary embedder 360A. The rotary embedder 360A may apply a weight matrix 305 on input data. The weight matrix 305 is represented by W_{R} in FIG. 3. The rotary embedder 360A may produce rotary positional encoded embeddings. In some embodiments, the operation of the rotary embedder 360A may be:

$$\begin{matrix}f ( {x}_{i} ) = {x}_{i} \cdot {w}_{r} - {x}_{i + 1} \cdot {w}_{i} , and \\ f ( {x}_{i + 1} ) = {x}_{i} \cdot {w}_{i} + {x}_{i + 1} \cdot {w}_{r} .\end{matrix}$$

where x is the input to the MatMul operator 320A, and w is weight. In an example, the dimension of the weight matrix 305 is 128×512.

The MatMul result computed by the MatMul operator 320B is provided to the rotary embedder 360B. The rotary embedder 360B may apply a weight matrix 306 on input data. The weight matrix 306 is represented by W_{R} in FIG. 3. The rotary embedder 360B may produce rotary positional encoded embeddings. In some embodiments, the operation of the rotary embedder 360B may be:

$$\begin{matrix}f ( {x}_{i} ) = {x}_{i} \cdot {w}_{r} - {x}_{i + 1} \cdot {w}_{i} , and \\ f ( {x}_{i + 1} ) = {x}_{i} \cdot {w}_{i} + {x}_{i + 1} \cdot {w}_{r} .\end{matrix}$$

where x is the input to the MatMul operator 320B, and w is weight. In an example, the dimension of the weight matrix 306 is 128×512.

The output of the rotary embedder 360A or rotary embedder 360B may be a vector. In an example, the dimension of the vector is 4. The output of the rotary embedder 360A is provided to the MatMul operator 320D. The MatMul operator 320D also receives keys from a KV cache 307. The cache 307 receives keys from the rotary embedder 360B, the MatMul operator 320D may perform a MatMul operation on the keys and the output of the rotary embedder 360A to compute a vector. In an example, the keys may be in a matrix, e.g., a matrix with a dimension of 2×<1024, in which<1024 may be a timestamp dimension T; the data received from the rotary embedder 360A may be a vector with a dimension of 2; and the output of the MatMul operator 320D may be a vector with a dimension of <1024.

The output of the MatMul operator 320D is provided to the SoftMax activator 330. The SoftMax activator 330 may apply a SoftMax function on the output of the MatMul operator 320D. The SoftMax function may be denoted as

$$\frac{{e}^{\frac{{x}_{i} - {x}_{max}}{\sqrt{64}}}}{{\sum }_{j = 0}^{t} {e}^{\frac{{x}_{j} - {x}_{max}}{\sqrt{64}}}} .$$

In an example, the output of the SoftMax activator 330 may be a vector with a dimension of <1024.

The output of the SoftMax activator 330 is provided to the MatMul operator 320E. The MatMul operator 320E also receives values from the cache 307. In some embodiments, at least some of the values are computed by the rotary embedder 360B. In an example, the values may be in a matrix, e.g., a matrix with a dimension of <1024×2, in which <1024 may be a timestamp dimension T; and the output of the MatMul operator 320E may be a vector with a dimension of 2. In some embodiments, T=1 for the first token. The context size may be denoted as Max T. In some embodiments, the MatMul operator 320D, SoftMax activator 330, and MatMul operator 320E may constitute a multi-headed attention block 314. In some embodiments, the DNN model 300 may include a plurality of multi-headed attention blocks 314 that can run in parallel. For instance, two embedding vectors may be split to two heads sized 2. The multi-headed attention block 314 may be a multi-headed attention layer.

The output of the MatMul operator 320E is input into the MatMul operator 320F. The MatMul operator 320F also receives a weight matrix 308. The weight matrix 308 is shown as W₀ in FIG. 3. In an example, the dimensions of the weight matrix 308 is 4×4. The data received by the MatMul operator 320F from the MatMul operator 320E may be a vector, whose dimension may be 4. The output of the MatMul operator 320F may be a vector, whose dimension may be 4.

The output of the MatMul operator 320F is provided to the add operator 340A. The operators 340A may perform an elementwise addition on the output of the MatMul operator 320F and the input to the RMS normalizer 310. In some embodiments, the elementwise addition is denoted as f(x,y)=x+y. In an example, the two inputs to the operators 340A may each be a vector with a dimension of 4, and the output of the operators 340B may also be a vector with a dimension of 4.

The output of the operators 340A is provided to the RMS normalizer 310B. The RMS normalizer 310B can standardize data it receives. The RMS normalizer 310B may perform an RMS normalization on the output of the operators 340A using a weight vector 309. In an example, the spatial size of the weight vector 301 may be 4. The RMS normalization may be denoted as

$$y = \frac{{x}_{i} \cdot {W}_{{RMS}_{i}}}{\sqrt{\frac{{\sum }_{j = 0}^{4 , 096} {x}_{j}^{2}}{4 , 096} + {10}^{- 5}}} ,$$

where i and j are indices, x is the input, W_{RMS} is the weight (which may be referred to as RMS attention weights), and y is the output. The weight vector 309 may also denoted as Wₙ₂. The RMS normalization can normalize data elements based on the RMS of the data elements. The normalization may stabilize the inputs and ensure that the attention weights can be computed on approximately scaled inputs, leading to better training stability and faster convergence. The output of the RMS normalizer 310B may be one or more tokens. In an example, the token may be represented by a 15-bit integer. In some embodiments, the output of the RMS normalizer 310B is a vector. In an example, the dimension of the vector is 4.

The output of the RMS normalizer 310B is provided to the MatMul operator 320G. The MatMul operator 320G also receives a weight matrix 311. The weight matrix 311 is shown as W₁ in FIG. 3. In an embodiment, the spatial shape of the weight matrix 311 is 4×10, the dimension of the output of the RMS normalizer 310B is 4, and the dimension of the output of the 320G is 10. The output of the MatMul operator 320G is provided to the SiLU activator 370. The SiLU activator 370 may apply a SiLU function on the output of the MatMul operator 320G, the SiLU function may be denoted as

$$f ( x ) = \frac{1}{x} .$$

The SiLU activator 370 may perform the SiLU operation in an elementwise manner, meaning for every data element input into the SiLU activator 370, the SiLU activator 370 applies the SiLU function and computes an output data element. In an example, the input to the SiLU activator 370 is a vector including 10 data elements, and the output of the SiLU activator 370 is also a vector including 10 data elements.

The output of the RMS normalizer 310B is also provided to the MatMul operator 320H. The MatMul operator 320H also receives a weight matrix 312. The weight matrix 312 is shown as W₃ in FIG. 3. In an embodiment, the spatial shape of the weight matrix 312 is 4×10, the dimension of the output of the RMS normalizer 310B is 4, and the dimension of the output of the 320H is 10.

The output of the MatMul operator 320H is provided to the product operator 350. The product operator 350 also receives the output of the SiLU activator 370. The product operator 350 may perform an elementwise multiplication on the two inputs. The elementwise multiplication may be denoted as f(x, y)=x·y. In some embodiments, the two inputs are each a vector including 10 data elements, and the output of the product operator 350 is also a vector including 10 data elements.

The output of the product operator 350 is provided to the MatMul operator 320I. The MatMul operator 320I also receives a weight matrix 313. The weight matrix 313 is shown as W₂ in FIG. 3. In an embodiment, the spatial shape of the weight matrix 313 is 10×4, the dimension of the output of the product operator 350 is 10, and the dimension of the output of the 320I is 4. In some embodiments, the MatMul operator 320G, 320H, product operator 350, and MatMul operator 320I may constitute a feed forward neural network 315. The 315 may be denoted as W₂(Silu(W₁(x))×W₃(x)). The feed forward neural network 315 can ensure rapid and effective data processing.

The output of the MatMul operator 320I is provided to the add operator 340B, the operators 340B also receives the output of the operators 340A. The operators 340B may perform an elementwise addition on the two inputs. The elementwise addition may be denoted as f(x,y)=x+y. In an example, the two inputs are each a vector including 4 data elements, and the output of the operators 340B is also a vector including 4 data elements. The output of the operators 340B may be an output of the DNN model 300.

FIG. 4 illustrates an integrated cell 400, in accordance with various embodiments. The integrated cell 400 can perform MatMul operations, such as MatMul operations in multi-headed attention blocks of DNNs. In some embodiments, the integrated cell 400 may perform vector multiplications. The integrated cell 400 may be an example of the RAM-multiply-add units 122 in FIG. 1. As shown in FIG. 4, the integrated cell 400 includes a memory array 410 and a computational unit 420. The memory array 410 and computational unit 420 are communicatively coupled. In other embodiments, the integrated cell 400 may include multiple memory arrays or computational units.

The memory array 410 may be the main storage area where the data (bits) are stored. In the context of a vector multiplication, the memory array 410 stores the vectors to be multiplied. The memory array 410 includes bit lines 425 (individually referred to as “bit line 425”), wordlines 430 (individually referred to as “wordline 430”), memory cells 440 (individually referred to as “memory cell 440”), a row driver 450, and a column driver 460. In other embodiments, the memory array 410 may include fewer, more, or different components.

A memory cell 440 is coupled to a bit line 425 and a wordline 430. In some embodiments, the memory cells in the memory array 410 are arranged in rows and columns. A row of memory cells may be coupled to a wordline 430. The wordline 430 may be used to access the memory cells 440 in the row. For instance, when the wordline 430 is activated, the row of memory cells 440 may be selected and accessed for data read operations or data write operations. The wordlines 430 may also be referred to as row select lines. A column of memory cells 440 may be connected to a bit line 425. The bit line 425 may be used to access the memory cells 440 in the column. For instance, when the bit line 425 is activated, the column of memory cells 440 may be selected and accessed for data read operations or data write operations. In some embodiments, each column of memory cells 440 is connected to two bit lines 425: a first bit line 425 and a second bit line 425 that is the inverse of the first bit line 425. A bit of data may be stored in a column of memory cells 440.

The row driver 450 may select which rows of memory cells 440 to be accessed based on memory addresses received from a logic circuit, such as the bit line 425. In some embodiments, the row driver 450 may receive an input signal with information indicating a memory address. The row driver 450 may decode the memory address and select the row(s) corresponding to the memory address. The row driver 450 may further activate the row(s), e.g., by selecting and enabling the wordline 430 of each selected row. After a row is selected and activated, the logic circuit can perform read or write operations on the memory cells in the row. In some embodiments, the row driver 450 may further include a row driver for each wordline 430 to drive a signal down the wordline 430. The row driver 450 may include a digital circuit that can be used to decode memory addresses, select rows of memory cells, or activate wordlines 430. The digital circuit may include one or more logic gates. In some embodiments, the row driver 450 may include one or more inverters to drive the wordline 430.

The column driver 460 selects which column(s) of memory cells to be accessed based on memory addresses received from a logic circuit, such as the bit line 425. The column driver 460 may decode a column address and activate the corresponding column of memory cells 440. The column driver 460 may include a digital circuit that can take the column address as input and generate one or more control signals that activate the corresponding column of memory cells 440. The digital circuit may include a combination of logic gates, such as AND gates and inverters, to decode the address and generate control signals. The number of inputs and outputs of the column driver 460 may depend on the size of the memory array 410. For example, in a memory system with 8 columns, the memory column decoder would have 3 address inputs (since 23=8) and 8 output signals, each corresponding to a specific column. When a particular column address is provided, the column driver 460 may activate the corresponding output signal, enabling the memory cells in that column for read or write operations. The row driver 450 and column driver 460 can facilitate efficient and accurate access to specific rows of memory cells within the memory array 410 and can support retrieval and storage of data in computer systems.

The row driver 450 or column driver 460 may include a buffer. The buffer may temporarily store data, such as signals received by or generated by the integrated cell 400. In some embodiments, the buffer may facilitate transmission of signals between the integrated cell 400 and another integrated cell 400 or between the integrated cell 400 and a control circuit. The buffer can speed up signal transmission in embodiments where there is a relatively large distance (e.g., 1 micron or greater) between the integrated cell 400 and the other integrated cell 400 or between the integrated cell 400 and the control circuit.

In some embodiments, signals may pass through the buffer before they arrive at the memory array 410. For example, a read request may be sent from a logic circuit, arrive at the integrated cell 400, then pass through the buffer to the row driver 450, the column driver 460, the memory array 410, or some combination thereof. The read data may travel back from the memory array 410 to the logic circuit through the buffer. In an embodiment, the read request may be stored in the buffer temporarily before the read request is transmitted to the row driver 450, the column driver 460, or the memory array 410. Similarly, the read data may be stored in the buffer temporarily before the read data is transmitted to the control circuit.

The row driver 450 or column driver 460 may include a sense amplifier. The sense amplifier may amplify and restore weak signals, e.g., to a more robust and usable level. In some embodiments, for reading data from the memory array 410, the sense amplifier may detect and amplify the small voltage difference between the stored data states, typically representing binary values of 0 and 1. By amplifying this voltage difference, the sense amplifier can enable accurate and reliable data retrieval. In some embodiments (e.g., embodiments having high-speed data transmission), the sense amplifier may amplify weak signals to avoid signal degradation and noise during signal propagation so that the signals can be more immune to noise, which can enable more accurate data recovery. The sense amplifier may be a latch-based sense amplifier, differential sense amplifier, dynamic sense amplifier, or other types of sense amplifiers.

The computational unit 420 includes a multiplier 470, multiplier 480, and adder 490. The multiplier 470 and multiplier 480 can perform multiplication operations on the data vectors stored in the memory array 410. The row driver 450 and column driver 460 may select the right weights and activations to be sent to the multiplier 470 and multiplier 480 for performing the multiplication operations. For example, the multiplier 470 may receive W1 (weight) and A1 (activation) and output the product W1×A1, and the multiplier 470 may receive W2 (weight) and A2 (activation) and output the product W2×A2. The adder 490 may then sum the results of the multiplications performed by the multiplier 470 and multiplier 480. In the example, it sums W1×A1 and W2×A2 to produce the final result, which would be an output of the integrated cell 400.

The architecture of the integrated cell 400 integrates computation within the memory array itself, thereby reducing data movement and improving efficiency for vector multiplication operations. This architecture can reduce data movement. By integrating computation within the memory array, this architecture can minimize the need to move data between memory and processing units. This architecture can also improve efficiency. The close proximity of storage and computation units can lead to faster and more energy-efficient operations, particularly beneficial for tasks like vector multiplication commonly used in machine learning and signal processing.

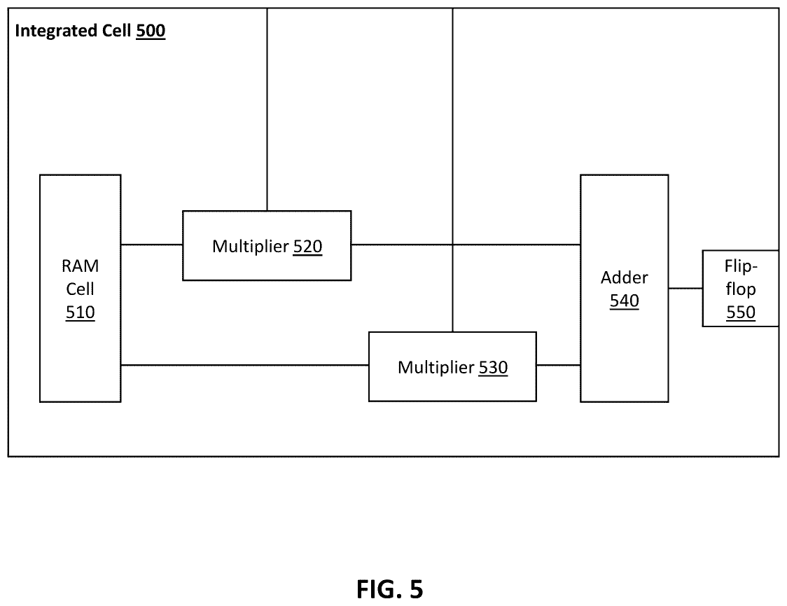

FIG. 5 illustrates an integrated cell 500 with a RAM-multiply-adder architecture, in accordance with various embodiments. The integrated cell 500 can perform MatMul operations, such as MatMul operations in multi-headed attention blocks of DNNs. The integrated cell 500 may be an example of the RAM-multiply-add units 122 in FIG. 1. As shown in FIG. 5, the integrated cell 500 includes a RAM cell 510, multiplier 520, multiplier 530, adder 540, and flip-flop 550. In other embodiments, the integrated cell 500 may include fewer, more, or different components. For example, the integrated cell 500 may include multiple RAM cells, adders, or flip-flops. As another example, the integrated cell 500 may include one multiplier or more than two multipliers. In the embodiments of FIG. 5, the RAM cell 510, multiplier 520, multiplier 530, adder 540, and flip-flop 550 are integrated within a single cell, i.e., the integrated cell 500.

The RAM cell 510 may be a DRAM cell or SRAM cell. The integrated cell 500 may be a matrix RAM-multiply-add unit. In an example, the RAM cell 510 is 8× the size of a weight. The RAM cell 510 may store values (e.g., weights) that are directly fed into the multiplier 520 and multiplier 530. For instance, the RAM cell 510 may store two weights (e.g., W1×2) at a time. The depth of the RAM cell 510 may be one. The depth of the RAM cell 510 may indicate the number of rows or the number of wordlines in the RAM cell 510.

The multiplier 520 and multiplier 530 may be two 8×8 multipliers. The multiplier 520 and multiplier 530 may take inputs A1 and A2 along with the RAM outputs (W1 and W2) and compute the products (W1A1 and W2A2), respectively. Each weight or activation may be 8-bit wide. The results of these multiplications are then fed into the adder 540. For instance, the adder 540 may receive W1A1 from the multiplier 520 and receive W2A2 from the multiplier 530. The adder 540 then sums the products to generate an output (O1). O1 may be referred to as a 1×1 matrix, which may be a scaler. The output may be stored in the flip-flop 550 before it is output from the integrated cell 500.

The integrated cell design shown in FIG. 5 can enhance DNN inference efficiency by minimizing the routing complexity and interconnecting delays that are typically associated with separate memories and multipliers in traditional designs. The integration into a singular, more cohesive structure can eliminate the need for extensive fabric, thereby optimizing overall performance and area utilization on the chip.

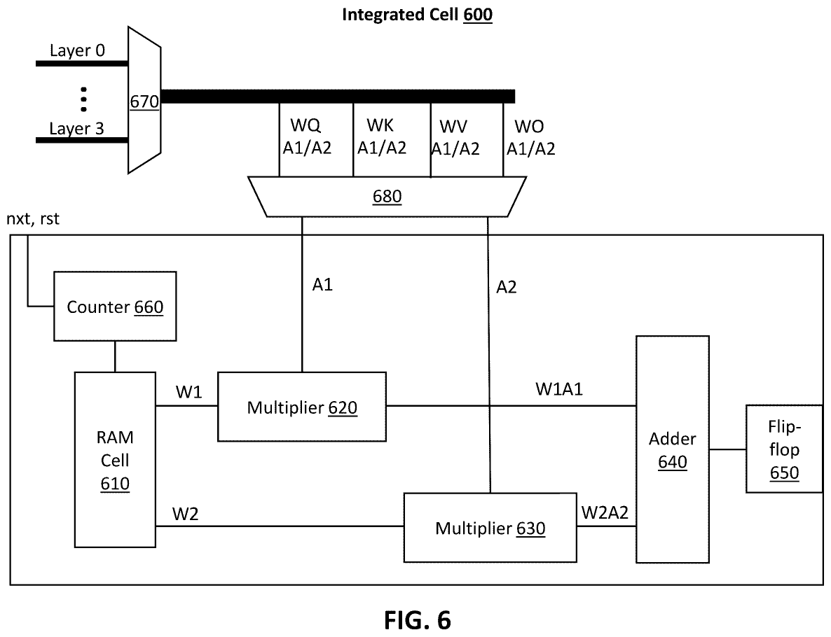

FIG. 6 illustrates an integrated cell 600 capable of handling different types of weights, in accordance with various embodiments. The integrated cell 600 can perform MatMul operations, such as MatMul operations in multi-headed attention blocks of DNNs. The integrated cell 600 may be an example of the RAM-multiply-add units 122 in FIG. 1. As shown in FIG. 6, the integrated cell 600 includes a RAM cell 610, multiplier 620, multiplier 630, adder 640, flip-flop 650, counter 660, multiplexer (MUX) 670, and MUX 680. In other embodiments, the integrated cell 600 may include fewer, more, or different components. In the embodiments of FIG. 6, the RAM cell 610, multiplier 620, multiplier 630, adder 640, flip-flop 650, counter 660, multiplexer (MUX) 670, and MUX 680 are integrated within a single cell, i.e., the integrated cell 600.

The RAM cell 610 may be a DRAM cell or SRAM cell. The RAM cell 610 may store values (e.g., weights) that are directly fed into the multiplier 620 and multiplier 630. The RAM cell 610 may have more rows than the RAM cell 510 in FIG. 5. In some embodiments, the RAM cell 610 may have a depth that is configured to accommodate different types of weights for various layers of a DNN model. The depth of the RAM cell 610 (e.g., the number of wordlines in the RAM cell 610) may equal the product of multiplying the number of weight types and the number of layers accommodated by the RAM cell 610. In an example, the RAM cell 610 may accommodate 4 types of weights across 32 layers, resulting in a total depth of 128. The types of weights stored in the RAM cell 610 may include W_{Q}, W_{K}, W_{V}, W_{O}, and so on. The counter 660 may facilitate transmission of appropriate weights to the multiplier 620 and multiplier 630 for multiplications. In some embodiments, the counter 660 may be controlled by one or more control signals, such as a next (nxt) signal and a reset (rst) signal, to iterate through the rows or columns of the RAM cell 610 for sequentially providing the appropriate weights (e.g., W1, W2) for multiplication.

The counter 660 can ensure that the correct weights are fetched for each layer and weight type, while the MUX 670 and MUX 680 can select the corresponding activation inputs and facilitate transmitting appropriate activations of appropriate layers to the multiplier 620 and multiplier 630. In some embodiments, the counter 660 may have a nxt pin and a rst pin for receiving the two types of signals, respectively. Each time new weights are needed, the nxt pin may be toggled and the correct activation may be mux-ed in through the MUX 670 and MUX 680.

The multiplier 620 and multiplier 630 may be two 8×8 multipliers. The multiplier 620 and multiplier 630 may take inputs A1 and A2 along with the RAM outputs (W1 and W2) and compute the products (W1A1 and W2A2), respectively. Each weight or activation may be 8-bit wide. The results of these multiplications are then fed into the adder 640. For instance, the adder 640 may receive W1A1 from the multiplier 620 and receive W2A2 from the multiplier 630. The adder 640 then sums the products to generate an output (O1). O1 may be referred to as a 1×1 matrix, which may be a scaler. The output may be stored in the flip-flop 650 before it is output from the integrated cell 600.

FIG. 6 shows an enhanced version of the optimized matrix RAM multiply-adder design. The design in FIG. 6 can be tailored to handle different types of weights for various layers in a DNN, such as the DNN model 300 in FIG. 3. Despite the enhanced flexibility and reusability of this design, it may produce a single output (O1). However, for a complete matrix-vector multiplication, especially when dealing with multiple weight types and layers, there may be two outputs (O1 and O2) to fully represent the 2×2 weight matrix multiplication result. This limitation may indicate the need for an additional adder and appropriate routing to generate the second output, ensuring the design can handle the full complexity of the matrix operations required for neural network computations.

FIG. 7 illustrates an integrated cell array 700 with a single column, in accordance with various embodiments. The integrated cell array 700 is a column of integrated cells. The integrated cell array 700 can perform MatMul operations, such as MatMul operations in multi-headed attention blocks of DNNs. The integrated cell array 700 may be an example of the RAM-multiply-add units 122 in FIG. 1. The integrated cell array 700 in FIG. 7 includes an integrated cell 710 stacked over another integrated cell 720. The integrated cell 710 and integrated cell 720 each include the components of the integrated cell 600 in FIG. 6. For the purpose of illustration and simplicity, the MUX 670 and MUX 680 are not shown in FIG. 7. In other embodiments, the integrated cell array 700 may include more than two integrated cells. The integrated cells in the integrated cell array 700 may be non-identical. Also, the integrated cell 710 or integrated cell 720 may include fewer, more, or different components.

The design in FIG. 7 is an optimized hardware design for matrix-vector multiplication using a multiply-adder architecture. In an example, the RAM cell 610 in each integrated cell of the integrated cell array 700 may store elements of the weight matrix (W) (e.g., with size 8× the input width). Inputs (A1) and (A2) represent the elements of the activation vector (A). The RAM outputs (W1) and (W2) include the weight matrix elements, which are multiplied by the respective activation inputs using the multipliers. The multiplier outputs (products) are then summed by the adder to generate the final output (O1) and (O2). This setup can effectively perform the matrix-vector multiplication of a 2×2 weight matrix (W) by a 2×1 activation vector (A) to produce a 2×1 output vector (O). In an example, the activator vector

$$A = [ \begin{matrix}{a}_{1} \\ {a}_{2}\end{matrix} ] ,$$

the weight matrix

$$W = [ \begin{matrix}{w}_{11} & {w}_{12} \\ {w}_{21} & {w}_{22}\end{matrix} ] ,$$

and the output vector

$$O = [ \begin{matrix}{w}_{11} \cdot {a}_{1} + {w}_{12} \cdot {a}_{2} \\ {w}_{21} \cdot {a}_{1} + {w}_{22} \cdot {a}_{2}\end{matrix} ] = [ \begin{matrix}{O}_{1} \\ {O}_{2}\end{matrix} ] .$$

The inclusion of counters can help in iterating through the RAM cells for sequential data processing. This design can be expanded by adding more rows and columns to accommodate larger matrices, thus providing a scalable and efficient solution for matrix operations in hardware.

FIG. 8 illustrates an integrated cell array 800 with multiple columns and rows, in accordance with various embodiments. The integrated cell array 800 is an array of integrated cells 810, individually referred to as “integrated cells 810.” The integrated cell array 800 can perform MatMul operations, such as MatMul operations in multi-headed attention blocks of DNNs. The integrated cell array 800 may be an example of the RAM-multiply-add units 122 in FIG. 1. The integrated cell array 800 in FIG. 8 includes eight integrated cells 810 arranged in two columns and four rows. The integrated cells 810 each include the components of the integrated cell 600 in FIG. 6. For the purpose of illustration and simplicity, the MUX 670 and MUX 680 are not shown in FIG. 8. The multiplier 620, multiplier 630, and adder 640 may constitute a dot product unit within the integrated cells 810. Each integrated cell 810 also includes an additional adder 820. The additional adder 820 may compute the sum of the output of the dot product unit with an output from another integrated cell 810. In other embodiments, the integrated cell array 800 fewer, more, or different components. For example, the integrated cell array 800 may include a different number of integrated cells. The integrated cells in the integrated cell array 800 may be non-identical. As another example, the shape of the integrated cell array 800 (e.g., the number of rows or the number of columns) may be different.

FIG. 8 shows an expanded matrix RAM multiply-adder design. This design can handle the multiplication of a 4×1 activation vector (A) by a 4×4 weights matrix (W), producing a 4×1 output vector (O). Each of the eight integrated cells 810 may handle specific rows and columns of the matrix-vector multiplication. In an example, the activator vector is

$$A = [ \begin{matrix}{a}_{1} \\ {a}_{2} \\ {a}_{3} \\ {a}_{4}\end{matrix} ] ,$$

the weight matrix

$$W = [ \begin{matrix}{w}_{11} & {w}_{12} & {w}_{13} & {w}_{14} \\ {w}_{21} & {w}_{22} & {w}_{23} & {w}_{4} \\ {w}_{31} & {w}_{32} & {w}_{33} & {w}_{34} \\ {w}_{41} & {w}_{42} & {w}_{43} & {w}_{44}\end{matrix} ] ,$$

and the output vector is:

$$O = [ \begin{matrix}{w}_{11} \cdot {a}_{1} + {w}_{12} \cdot {a}_{2} + {w}_{13} \cdot {a}_{3} + {w}_{14} \cdot {a}_{4} \\ {w}_{21} \cdot {a}_{1} + {w}_{22} \cdot {a}_{2} + {w}_{23} \cdot {a}_{3} + {w}_{24} \cdot {a}_{4} \\ {w}_{31} \cdot {a}_{1} + {w}_{32} \cdot {a}_{2} + {w}_{33} \cdot {a}_{3} + {w}_{34} \cdot {a}_{4} \\ {w}_{41} \cdot {a}_{1} + {w}_{42} \cdot {a}_{2} + {w}_{43} \cdot {a}_{3} + {w}_{44} \cdot {a}_{4}\end{matrix} ] = [ \begin{matrix}{O}_{1} \\ {O}_{2} \\ {O}_{3} \\ {O}_{4}\end{matrix} ] .$$

In some embodiments, each row of the integrated cell array 800 may correspond to and compute a particular one of the output elements (O1) to (O4). The RAM cells in the integrated cell array 800 may store different subsets of the weight matrix elements, ensuring that each unit processes the appropriate weights for its corresponding output calculation. For each row, the multipliers take the four activations and the weights from the RAM cells, computing the products. The adders then sum these products to generate the output (O1) to (O4). The counters may control the iteration through the RAM cells, and the MUXs may ensure the correct activation inputs are selected.

FIG. 9 illustrates time multiplexing for an exemplary MatMul operation, in accordance with various embodiments. In some embodiments, the time multiplexing mechanism shown in FIG. 9 may be used for MatMul operations with odd sized matrices. Whether matrices are odd sized or not may depend on the architecture of the hardware that performs the MatMul operation. For instance, the sizes of the weight tensor and activation tensor of an MatMul operation may determine the total number of multiply-accumulate (MAC) operations in the MatMul operation. When the total number of MAC operations does not match the dimension(s) of the hardware, the MatMul operation may be considered as an MatMul operation with odd sized matrices, which is also referred to as an odd sized MatMul operation. To optimize the efficiency of the hardware running an odd sized MatMul operation, time multiplexing may be used. Additionally or alternatively, the MatMul operation may be converted.

As an example, FIG. 9 shows time multiplexing for a MatMul operation with a 10×4 weight matrix and a 4×1 activation vector. Given the size of the weight matrix and activation vector, the MatMul operation includes 10 MAC operations for computing 10 output elements. The MatMul operation may be an example of the MatMul operator 320G and MatMul operator 320H in FIG. 3. In embodiments where the MatMul operation is performed by an integrated cell array with four rows, such as the integrated cell array 800, the MatMul operation may be converted by adding two extra MAC operations so that the total number of MAC operation would be a multiple of the number of rows of the integrated cell array. The converted MatMul operation may be carried out through three computational cycles of the integrated cell array. In some embodiments, the computational cycles are clock cycles, which may be determined by a flow control unit, such as the flow control unit 111 in FIG. 1.

For instance, the MatMul operation may be converted to:

$$[ \begin{matrix}{w}_{11} \cdot {a}_{1} + {w}_{21} \cdot {a}_{2} + {w}_{31} \cdot {a}_{3} + {w}_{41} \cdot {a}_{4} \\ {w}_{12} \cdot {a}_{1} + {w}_{22} \cdot {a}_{2} + {w}_{32} \cdot {a}_{3} + {w}_{42} \cdot {a}_{4} \\ {w}_{13} \cdot {a}_{1} + {w}_{23} \cdot {a}_{2} + {w}_{33} \cdot {a}_{3} + {w}_{43} \cdot {a}_{4} \\ {w}_{14} \cdot {a}_{1} + {w}_{24} \cdot {a}_{2} + {w}_{34} \cdot {a}_{3} + {w}_{44} \cdot {a}_{4} \\ {w}_{15} \cdot {a}_{1} + {w}_{25} \cdot {a}_{2} + {w}_{35} \cdot {a}_{3} + {w}_{45} \cdot {a}_{4} \\ {w}_{16} \cdot {a}_{1} + {w}_{26} \cdot {a}_{2} + {w}_{36} \cdot {a}_{3} + {w}_{46} \cdot {a}_{4} \\ {w}_{17} \cdot {a}_{1} + {w}_{27} \cdot {a}_{2} + {w}_{37} \cdot {a}_{3} + {w}_{47} \cdot {a}_{4} \\ {w}_{18} \cdot {a}_{1} + {w}_{28} \cdot {a}_{2} + {w}_{38} \cdot {a}_{3} + {w}_{48} \cdot {a}_{4} \\ {w}_{18} \cdot {a}_{1} + {w}_{29} \cdot {a}_{2} + {w}_{39} \cdot {a}_{3} + {w}_{49} \cdot {a}_{4} \\ {w}_{101} \cdot {a}_{1} + {w}_{210} \cdot {a}_{2} + {w}_{310} \cdot {a}_{3} + {w}_{410} \cdot {a}_{4} \\ 0 \cdot {a}_{1} + 0 \cdot {a}_{2} + 0 \cdot {a}_{3} + 0 \cdot {a}_{4} \\ 0 \cdot {a}_{1} + 0 \cdot {a}_{2} + 0 \cdot {a}_{3} + 0 \cdot {a}_{4}\end{matrix} ] = [ \begin{matrix}{O}_{1} \\ {O}_{2} \\ {O}_{3} \\ {O}_{4} \\ {O}_{5} \\ {O}_{6} \\ {O}_{7} \\ {O}_{8} \\ {O}_{9} \\ {O}_{10} \\ 0 \\ 0\end{matrix} ] ,$$

in which two extra MAC operations are added. O₁ through O₄ may be computed in the first clock cycle (shown as “clk1” in FIG. 9), O₅ through O₈ may be computed in the second clock cycle (shown as “clk2” in FIG. 9), and the rest may be computed in the third clock cycle (shown as “clk3” in FIG. 9).

During each clock cycle, the activations may remain unchanged. For instance, the integrated cells 810 in the first column receive a₁ and a₂, which are used by these integrated cells 810 for all the three clock cycles. The integrated cells 810 in the second column receive a₃ and a₄, which are used by these integrated cells 810 for all the three clock cycles. The weights processed by the integrated cells 810 may be updated for each clock cycle, e.g., by the counters in the integrated cell array 800. For the first clock cycle: the first row of the integrated cell array 800 may receive w₁₁, w₂₁, w₃₁, and w₄₁; the second row of the integrated cell array 800 may receive w₁₂, w₂₂, w₃₂, and w₄₂; the third row of the integrated cell array 800 may receive w₁₃, w₂₃, w₃₃, and w₄₃; the fourth row of the integrated cell array 800 may receive w₁₄, w₂₄, w₃₄, and w₄₄. For the second clock cycle: the first row of the integrated cell array 800 may receive w₁₅, w₂₅, w₃₅, and w₄₅; the second row of the integrated cell array 800 may receive w₁₆, w₂₆, w₃₆, and w₄₆; the third row of the integrated cell array 800 may receive w₁₇, w₂₇, w₃₇, and w₄₇; the fourth row of the integrated cell array 800 may receive w₁₈, w₂₈, w₃₈, and w₄₈. For the third clock cycle: the first row of the integrated cell array 800 may receive w₁₉, w₂₉, w₃₉, and w₄₉; the second row of the integrated cell array 800 may receive w₁₁₀, w₂₁₀, w₃₁₀, and W₄₁₀; the third row of the integrated cell array 800 may receive 0, 0, 0, and 0; the fourth row of the integrated cell array 800 may receive 0, 0, 0, and 0.

With the time multiplexing, the integrated cell array 800 can perform this odd sized MatMul operation without changing the hardware architecture. The time multiplexing mechanism can facilitate the integrated cell array 800 to perform other odd sized MatMul operations. This approach can optimize resource utilization and avoid unnecessary hardware expansion. FIG. 9 shows a series of flip-flops 910A-910J, which may store the 10 output elements of the MatMul operation, respectively.

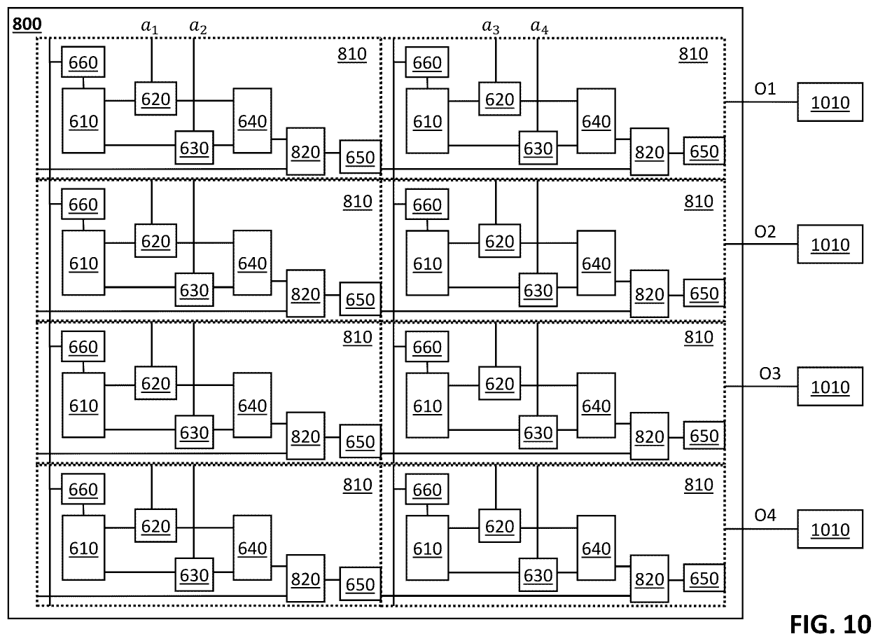

FIG. 10 illustrates time multiplexing for another exemplary matrix multiplication operation, in accordance with various embodiments. For the purpose of illustration, the MatMul operation in the example of FIG. 10 has a 4×10 weight matrix and a 10×1 activation vector. The MatMul operation may be an example of the MatMul operator 320I in FIG. 3. The MatMul operation may be performed by the integrated cell array 800 through three clock cycles (clk1, clk2, and clk3). The integrated cell array 800 is coupled with four add units 1010 (individually referred to as “add unit 1010”). As shown in FIG. 10, each add unit 1010 is coupled with a different row in the integrated cell array 800 to sum outputs of the integrated cells 810 in the row. In other embodiments, each add unit 1010 may be coupled with a different column of the integrated cell array 800 to sum outputs of the integrated cells 810 in the column.

The MatMul operation may be converted to:

$$[ \begin{matrix}{w}_{11} \cdot {a}_{1} + {w}_{21} \cdot {a}_{2} + {w}_{31} \cdot {a}_{3} + {w}_{41} \cdot {a}_{4} + {w}_{51} \cdot {a}_{5} + {w}_{61} \cdot {a}_{6} + {w}_{71} \cdot {a}_{7} + {w}_{81} \cdot {a}_{8} + {w}_{91} \cdot {a}_{9} + {w}_{101} \cdot {a}_{10} + 0 \cdot {a}_{11} + 0 \cdot {a}_{12} \\ {w}_{12} \cdot {a}_{1} + {w}_{22} \cdot {a}_{2} + {w}_{32} \cdot {a}_{3} + {w}_{42} \cdot {a}_{4} + {w}_{52} \cdot {a}_{5} + {w}_{62} \cdot {a}_{6} + {w}_{72} \cdot {a}_{7} + {w}_{82} \cdot {a}_{8} + {w}_{92} \cdot {a}_{9} + {w}_{102} \cdot {a}_{10} + 0 \cdot {a}_{11} + 0 \cdot {a}_{12} \\ {w}_{13} \cdot {a}_{1} + {w}_{23} \cdot {a}_{2} + {w}_{33} \cdot {a}_{3} + {w}_{43} \cdot {a}_{4} + {w}_{53} \cdot {a}_{5} + {w}_{63} \cdot {a}_{6} + {w}_{73} \cdot {a}_{7} + {w}_{83} \cdot {a}_{8} + {w}_{93} \cdot {a}_{9} + {w}_{103} \cdot {a}_{10} + 0 \cdot {a}_{11} + 0 \cdot {a}_{12} \\ {w}_{14} \cdot {a}_{1} + {w}_{24} \cdot {a}_{2} + {w}_{34} \cdot {a}_{3} + {w}_{44} \cdot {a}_{4} + {w}_{54} \cdot {a}_{5} + {w}_{64} \cdot {a}_{6} + {w}_{74} \cdot {a}_{7} + {w}_{84} \cdot {a}_{8} + {w}_{94} \cdot {a}_{9} + {w}_{104} \cdot {a}_{10} + 0 \cdot {a}_{11} + 0 \cdot {a}_{12}\end{matrix} ]$$

The MatMul operation may be partitioned into 12 MAC operations. Each clock cycle may correspond to four MAC operations output of the 12 MAC operations. For instance, in the first clock cycle (clk1), the integrated cell array 800 may compute:

$$[ \begin{matrix}{w}_{11} \cdot {a}_{1} + {w}_{21} \cdot {a}_{2} + {w}_{31} \cdot {a}_{3} + {w}_{41} \cdot {a}_{4} \\ {w}_{12} \cdot {a}_{1} + {w}_{22} \cdot {a}_{2} + {w}_{32} \cdot {a}_{3} + {w}_{42} \cdot {a}_{4} \\ {w}_{13} \cdot {a}_{1} + {w}_{23} \cdot {a}_{2} + {w}_{33} \cdot {a}_{3} + {w}_{43} \cdot {a}_{4} \\ {w}_{14} \cdot {a}_{1} + {w}_{24} \cdot {a}_{2} + {w}_{34} \cdot {a}_{3} + {w}_{44} \cdot {a}_{4}\end{matrix} ] .$$

In the second clock cycle (clk2), the integrated cell array 800 may compute:

$$[ \begin{matrix}{w}_{51} \cdot {a}_{5} + {w}_{61} \cdot {a}_{6} + {w}_{71} \cdot {a}_{7} + {w}_{81} \cdot {a}_{8} \\ {w}_{52} \cdot {a}_{5} + {w}_{62} \cdot {a}_{6} + {w}_{72} \cdot {a}_{7} + {w}_{82} \cdot {a}_{8} \\ {w}_{53} \cdot {a}_{5} + {w}_{63} \cdot {a}_{6} + {w}_{73} \cdot {a}_{7} + {w}_{83} \cdot {a}_{8} \\ {w}_{54} \cdot {a}_{5} + {w}_{64} \cdot {a}_{6} + {w}_{74} \cdot {a}_{7} + {w}_{84} \cdot {a}_{8}\end{matrix} ] .$$

In the second clock cycle (clk3), the integrated cell array 800 may compute:

$$[ \begin{matrix}{w}_{91} \cdot {a}_{9} + {w}_{101} \cdot {a}_{10} + 0 \cdot {a}_{11} + 0 \cdot {a}_{12} \\ {w}_{92} \cdot {a}_{9} + {w}_{102} \cdot {a}_{10} + 0 \cdot {a}_{11} + 0 \cdot {a}_{12} \\ {w}_{93} \cdot {a}_{9} + {w}_{103} \cdot {a}_{10} + 0 \cdot {a}_{11} + 0 \cdot {a}_{12} \\ {w}_{94} \cdot {a}_{9} + {w}_{104} \cdot {a}_{10} + 0 \cdot {a}_{11} + 0 \cdot {a}_{12}\end{matrix} ] .$$

During each clock cycle, the activations and weights provided to the integrated cells 810 may be updated, e.g., by using the MUXs or counters in the integrated cell array 800. The results of the MAC operations performed in a clock cycle may be accumulated and saved for the next cycle. For instance, the add units 1010 may each include a flip-flop for storing the output of the corresponding row after the first clock cycle. After the second clock cycle, each add unit 1010 may receive the output of the corresponding row and sum it with the output of the row from the first clock cycle. The intermediate sum may be stored in the flip-flop of the add unit 1010. After the third clock cycle, each add unit 1010 may receive the new output of the corresponding row and sum it with the intermediate sum to compute the final output. For instance, O₁ may be the sum of the three results that are computed by the first row of the integrated cell array 800 in the three clock cycles, respectively; O₂ may be the sum of the three results that are computed by the first row of the integrated cell array 800 in the three clock cycles, respectively; O₃ may be the sum of the three results that are computed by the first row of the integrated cell array 800 in the three clock cycles, respectively; and O₄ may be the sum of the three results that are computed by the first row of the integrated cell array 800 in the three clock cycles, respectively.

In some embodiments, the size of each RAM cell may expand 8× for each weight, accommodating the larger weights matrix. In the third clock cycle (clk3), the last two entries may be forced to zero to ensure that no data elements other than the needed outputs are computed. The architecture of the integrated cell array 800 features multiple integrated cells, each performing the required multiplications and additions. As described above, each integrated cell may include a RAM cell, counter, multipliers, and one or more adders, with the final output elements being accumulated and stored in flip-flops for subsequent operations. This design can efficiently utilize the existing hardware, allowing for the multiplication of larger matrices without the need for additional resources.

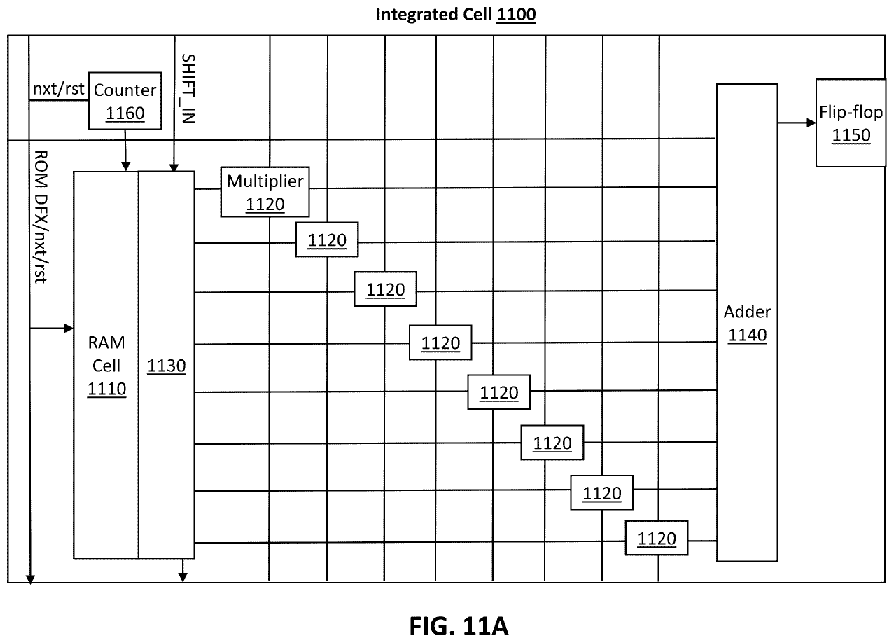

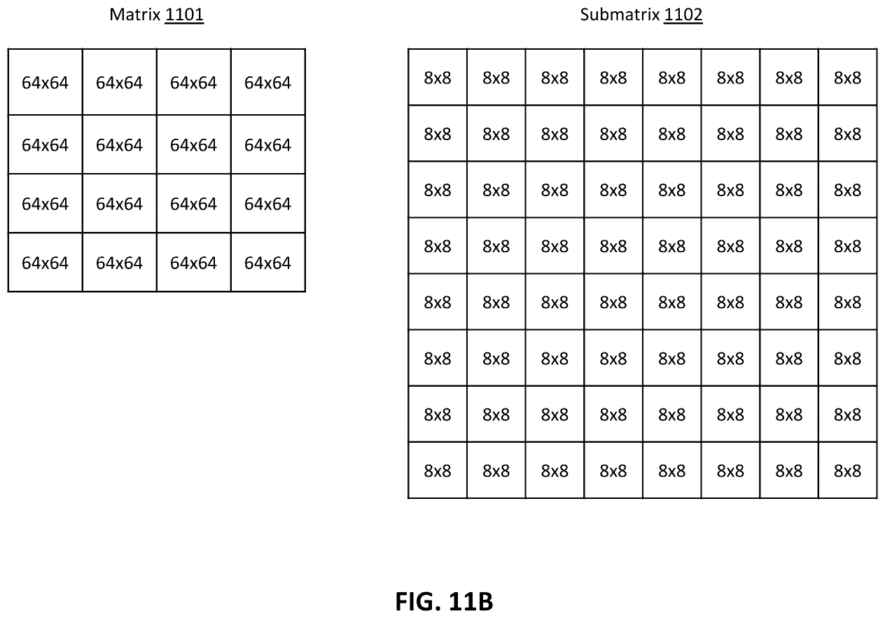

FIG. 11A illustrates an integrated cell 1100 with a repair unit 1130, in accordance with various embodiments. The integrated cell 1100 also includes a RAM cell 1110, eight multipliers 1120 (individual referred to as “multiplier 1120”), an adder 1140, a flip-flop 1150, and a counter 1160. In other embodiments, the integrated cell 1100 may include fewer, more, or different components. In some embodiments, the RAM cell 1110 has a depth of 64. The RAM cell 1110 may be a 8×8 RAM unit. The repair unit 1130 may support Design for Testability (DFX) for the RAM cell 1110. The repair unit 1130 with DFX can make it easier to develop and apply tests to the integrated cell 1100. At least the RAM cell 1110 and eight multipliers 1120 may constitute a 8×1 RAMUL unit. The integrated cell 1100 may be a 8×1 RAMUL-ADD unit. Each multiplier 1120 may be a 8×8 multiplier. In some embodiments, each multiplier 1120 may receive a weight and an activation and multiply the weight with the activation to compute a product. The weight or activation may be an 8-bit floating-point value. The products of the multipliers 1120 may be 10-bit floating-point values. The products of the multipliers 1120 are provided to the adder 1140, which computes a sum. The sum may be a 16-bit floating-point value. The sum may be stored in the flip-flop 1150. The counter 1160 may facilitate transmission of appropriate weights from the RAM cell 1110 to the multipliers 1120.

The integrated cell 1100 may be used to perform MatMul operations with relatively large matrices. In some embodiments, a 4×4 matrix may be too small to be practical. The matrix sizes of MatMul operations in a DNN may fall between 4×4 and 256×256, with a more likely optimal range being around 32×32. This range may strike a balance where RAM densities are more efficient and manageable, and the delays between cells necessitate a flip-flop to maintain synchronization. FIG. 11B illustrates decomposing an exemplary MatMul operation, in accordance with various embodiments. FIG. 11B shows partition of a large matrix 1101. The large matrix 1101 may be a weight matrix, activation matrix, or output matrix of the MatMul operation. As an example, the matrix 1101 is a 256×256 matrix. The matrix 1101 is divided into smaller, more manageable 64×64 submatrices 1102, individually referred to as “submatrix 1102”. Each submatrix 1102 may be further decomposed into 8×8 blocks. Each block may be stored in the RAM cell 1110 and processed by the multipliers 1120 and adder 1140. This hierarchical approach can ensure scalability and efficiency in hardware design. Additionally, as RAM sizes increase, incorporating a repair mechanism with DFX can ensure reliability and maintainability of the system. This approach can allow the architecture to handle larger matrix computations while optimizing resource usage and ensuring robust performance.

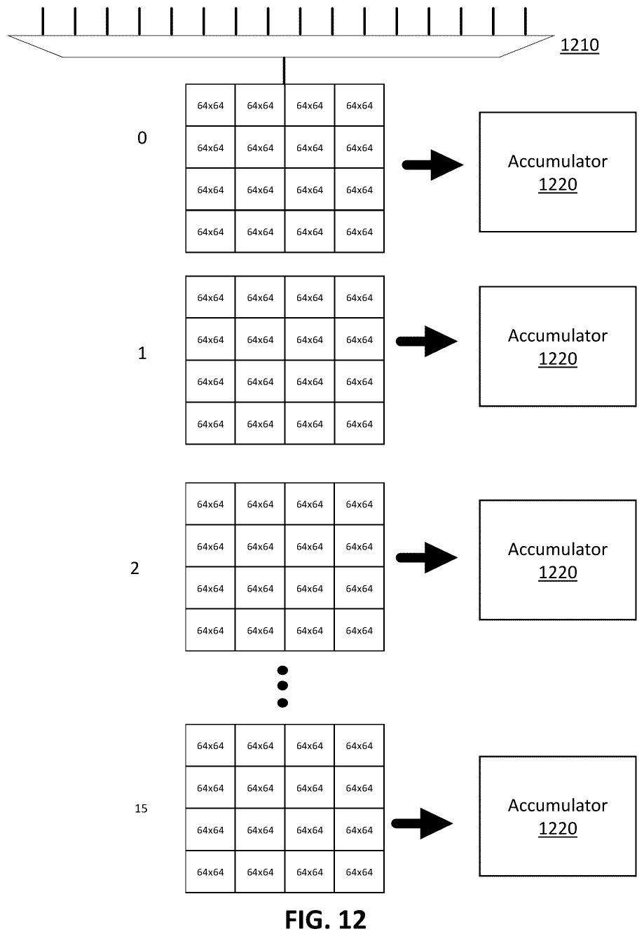

FIG. 12 illustrates decomposing an exemplary matrix multiplication operation, in accordance with various embodiments. For the purpose of illustration, the example shown in FIG. 12 is a MatMul operation with a 4096×4096 matrix. The 4096×4096 matrix is divided into 16 256×256 matrices. Each 256×256 matrix is further divided into 16 64×64 submatrices. The 16 sets of activations are multiplexed using a MUX 1210, allowing for efficient data processing within the system. Each set of 16 64×64 submatrices may be processed sequentially, e.g., by one or more integrated cells, such as the integrated cell 1100 as described above. The results from each submatrix may be accumulated by accumulators 1220. This hierarchical and modular approach can ensure that the computation of large matrices is both feasible and efficient, leveraging smaller, optimized matrix operations to achieve the overall result. The accumulation of results from each subset ensures that the final output is correctly computed, maintaining the integrity of the large-scale matrix operation. This method can allow for the scalability of hardware resources and efficient management of computational tasks.

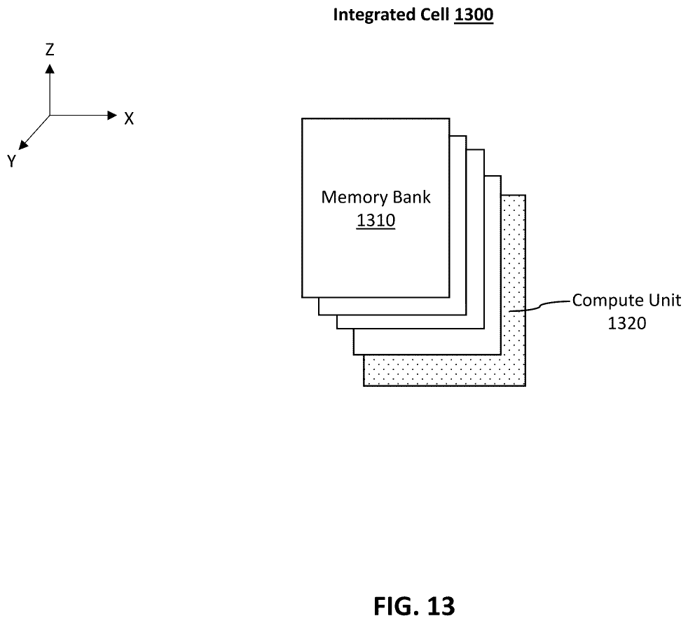

FIG. 13 illustrates a 3D integrated cell 1300, in accordance with various embodiments. The 3D integrated cell 1300 may be an example of the integrated cells described above. The 3D integrated cell 1300 includes memory banks 1310 (individually referred to as “memory bank 1310”) and a compute unit 1320. In other embodiments, the 3D integrated cell 1300 may include fewer, more, or different components. For instance, the 3D integrated cell 1300 may include a different number of memory banks.

The memory banks 1310 may be DRAM or SRAM banks. The compute unit 1320 may include arithmetic units, such as multipliers and adders. The compute unit 1320 may be a multiplier-adder. An example of the compute unit 1320 is the computational unit 420 in FIG. 4. As shown in FIG. 13, the memory banks 1310 are stacked over each other and placed over the compute unit 1320, which constitutes a RAM-based processing next-to-memory system. The compute unit 1320 can perform computations directly within the memory. This architecture can reduce data movement between the processor and memory, thereby improving computational efficiency and reducing latency, which is particularly beneficial for data-intensive applications like machine learning and scientific simulations.

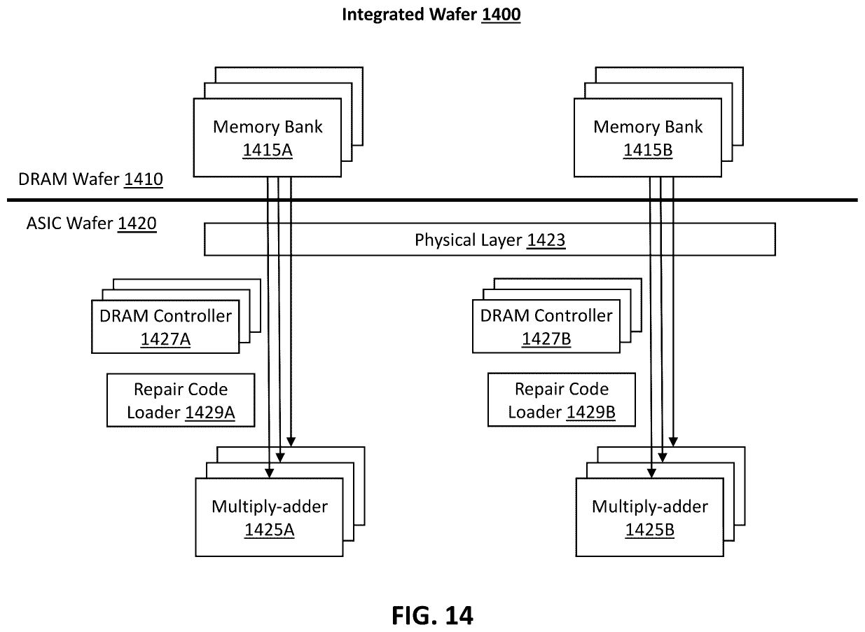

FIG. 14 illustrates an integrated memory-compute system 1400, in accordance with various embodiments. The integrated memory-compute system 1400 may implement DNNs, including LLMs. The integrated memory-compute system 1400 may be designed to enhance the processing efficiency of DNNs. The integrated memory-compute system 1400 may be an example of the IC device 100 in FIG. 1. The integrated memory-compute system 1400 may include a plurality of integrated cells, such as the integrated cells described above in conjunction with FIGS. 4-12. As shown in FIG. 14, the integrated memory-compute system 1400 includes a DRAM wafer 1410 and an application-specific integrated circuit (ASIC) wafer 1420. The DRAM wafer 1410 may be placed on top of the ASIC wafer 1420. The DRAM wafer 1410 may be an example of a memory wafer, such as the memory layer 210 in FIG. 2A. The ASIC wafer 1420 may be an example of a logic wafer, such as the logic layer 220 in FIG. 2A. The integrated memory-compute system 1400 may be an integrated wafer or stacked wafer.

The DRAM wafer 1410 includes memory banks 1415A and memory banks 1415B, which are two memory bank groups. For the purpose of illustration, each memory bank group has three memory banks. In other examples, a memory bank group may include fewer or more memory banks. The memory banks 1415A and memory banks 1415B may be storage units where model weights and activation vectors are stored. The dual memory bank groups can ensure high bandwidth and parallel access to data.

The ASIC wafer 1420 includes a physical layer 1423, multiply-adders 1425A, multiply-adders 1425B, DRAM controllers 1427A, DRAM controllers 1427B, repair code loader 1429A, and repair code loader 1429B. In other embodiments, the ASIC wafer 1420 may include fewer, more, or different components. The physical layer 1423 may facilitate physical data transfer between the DRAM wafer 1410 and ASIC wafer 1420, such as data transfer between the memory banks 1415A (or memory banks 1415B) and the multiply-adders 1425A (or multiply-adders 1425B). In an example, the physical layer 1423 is a Peripheral Component Interconnect Express (PCIe) physical layer. The physical layer 1423 can ensure reliable, high-speed communication.

The DRAM controllers 1427A and DRAM controllers 1427B may manage the read and write operations to the memory banks 1415A and memory banks 1415B, respectively. The DRAM controllers 1427A and DRAM controllers 1427B can optimize data flow and maintain data integrity. The DRAM controllers 1427A and DRAM controllers 1427B may interface with the repair code loader 1429A and repair code loader 1429B, respectively. The repair code loader 1429A and repair code loader 1429B may perform error detection and correction, ensuring data integrity within the DRAM wafer 1410.

The multiply-adders 1425A and multiply-adders 1425B may be specialized computational units that perform multiply-add operations, which are fundamental for neural network computations, such as MatMul operations. The multiply-adders 1425A and multiply-adders 1425B may process the data fetched from the memory banks 1415A and memory banks 1415B, respectively, and execute the core arithmetic functions required by the DNN model. For instance, each of the multiply-adders 1425A may receive data (e.g., weights or activations) from one of the memory banks 1415A and perform multiply-accumulate operations on the data. Similarly, each of the multiply-adders 1425B may receive data (e.g., weights or activations) from one of the memory banks 1415B and perform multiply-accumulate operations on the data. In some embodiments, each of the memory banks 1415A and the corresponding one of the multiply-adders 1425A may form an integrated cell. Similarly, each of the memory banks 1415B and the corresponding one of the multiply-adders 1425B may form an integrated cell. The ASIC wafer 1420 may have an arrange of integrated cells. In the example of FIG. 14, the array may have three rows and two columns. In other examples, the array may have a different number of rows or columns.

This architecture of an integrated memory-compute system 1400 can not only minimize data transfer latency, significantly improving computational speed and energy efficiency, but also facilitate effective heat removal, enhancing the chip's overall thermal management. In some embodiments, power supply may be designed to come from the bottom, allowing for the support of larger models and easier scaling. Such a design can be particularly beneficial for applications requiring real-time processing and high-performance AI capabilities, making it an ideal solution for industries ranging from healthcare and finance to autonomous systems and advanced machine learning tasks.

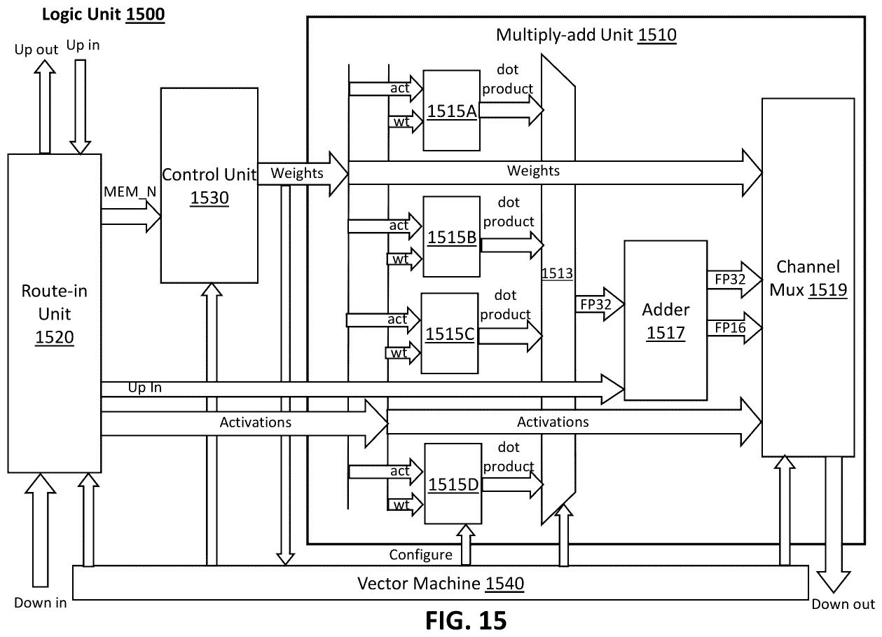

FIG. 15 illustrates a logic unit 1500 with a multiply-add unit 1510, in accordance with various embodiments. The logic unit 1500 may be at least part of a logic die. The logic die may be coupled with a memory die (not shown in FIG. 15) to form an integrated die, which may be an example of the integrated cells described above. In some embodiments, the logic die may be in a logic wafer that includes one or more other logic dies. In addition to the multiply-add unit 1510, the logic unit 1500 also includes a route-in unit 1520, a control unit 1530, and a vector machine 1540. In other embodiments, the logic unit 1500 may include fewer, more, or different components.

The multiply-add unit 1510 may perform multiplication and accumulation (e.g., multiply-accumulate operations) of weights and activation vectors. The multiplication and accumulation may be computations in MatMul operations of DNNs, such as transformers. The multiply-add unit 1510 may handle weights and activations with various data formats. In some embodiments, the multiply-add unit 1510 is split into multiply-adder channels to allow for computing multiple matrix rows at a time or take advantage of the partition channel width. For the purpose of illustration, FIG. 15 shows four channels. In other embodiments, the multiply-add unit 1510 may have fewer or more channels. The four channels may each have its own dot product logic for computing its portion of the matrix multiplication. As shown in FIG. 15, the four channels have dot product units 1515A-1515D, respectively. Each of the dot product units 1515A-1515D may compute dot products in the corresponding channel. Each of the dot product units 1515A-1515D may include one or more multipliers and an adder. Each of the dot product units 1515A-1515D may receive one or more activation-weight pairs at a time and compute a dot product through multiplication and accumulation. In some embodiments, each of the dot product units 1515A-1515D may operate on a unique section of the matrix.

The dot product units 1515A-1515D may be designed or configured to perform computations of various data types to allow for different types of quantization and precision. In an example, the dot product unit 1515A may perform FP16×FP16 multiplications, the dot product unit 1515B may perform FP8×FP8 multiplications, the dot product unit 1515C may perform INT4×FP8 multiplications, and the dot product unit 1515D may perform FP4×FP8 multiplications. The first data format may be the data format of weights, the second data format may be the data format of activations. FP stands for floating-point, and INT stands for integer. Each of these operations may be converted to FP32 before the correct number is multiplexed out and optionally accumulated. The dot products output from the dot product units 1515A-1515D may be FP32 values.

The multiply-add unit 1510 also includes a MUX 1513, an adder 1517, and a channel MUX 1519. The MUX 1513 may receive dot products computed by the dot product units 1515A-1515D and as input signals and select one of the input signals to output. The output of the MUX 1513 is provided to an adder 1515. The adder 1515 may add and convert the results from the dot product units 1515A-1515D. The adder 1515 may ensure that the final output is in the required format. For instance, the adder 1517 may accumulate the output of the MUX 1513 with one or more values received from one or more other multiplier-adders, represented by “down in” and “up in” in FIG. 15. The output of the adder 1517 may be a FP32 or FP16 value. A channel MUX 1519 may channel the processed data out of the multiply-add unit 1510 or the logic unit 1500, making it available for further processing or output may select a value to output. The output of the multiply-add unit 1510 may be the output of the logic unit 1500 (represented by “down out” in FIG. 15), which may be sent to another logic unit for further computation. For instance, the adder in the other logic unit for further computation may sum the output of the logic unit 1500 with a dot product computed by a multiplier in the other logic unit.

In some embodiments, partial unique weights may be stored in a channel while the other weights are not stored in the channel. The full set of activations may be stored in each channel to complete the matrix row. In some embodiments, weights and activations are stored in the memory bank(s) coupled with the logic unit 1500. The memory bank(s) may be RAM bank(s). The weights and activations may be loaded from the memory bank(s) into the route-in unit 1520. The route-in unit 1520 may have an interconnect fabric (e.g., a PCIe fabric) and one or more registers. The interconnect fabric may facilitate data transfer between the logic unit 1500 with memory bank(s) coupled with the logic unit 1500. The interconnect fabric may facilitate data transfer between the integrated cell comprising the logic unit 1500 with one or more other integrated cells. As shown in FIG. 15, the control unit 1530 receives external data (represented by “up in” and “down in”) and send out data (represented by “down in”). The route-in unit 1520 may route incoming data through the fabric and manage the one or more registers for optimal data flow. The weights and activations may be stored in the registers temporarily.

The control unit 1530 may manage memory operations (e.g., data transfer operations) and ensure data integrity by performing repairs when error is detected. The control unit 1530 may detect whether a data transfer operation has any error. In embodiments where the control unit 1530 detects an error, the control unit 1530 may repair the error before the data transfer operation may be performed. The control unit 1530 may receive memory information (“MEM_N”) from the route-in unit 1520. The memory information may be memory addresses that the control unit 1530 may use to manage memory operations. The control unit 1530 may include one or more RAM controllers (e.g., the DRAM controllers 1427A or DRAM controllers 1427B) and one or more repair code loaders (e.g., the repair code loader 1429A or repair code loader 1429B).

The vector machine 1540 may direct the flow of the multiply-accumulate operations in the logic unit 1500. The vector machine 1540 may be part of the flow control unit 111 in FIG. 1 or receive instructions from the flow control unit 111. In some embodiments, the vector machine 1540 may control the source and destination of weights and activations. The vector machine 1540 may be a RAM or channel vector machine. In some embodiments, the vector machine 1540 may be a simplified processor which contains instructions on how to direct the flow of data within the multiply-add unit 1510. For instance, the vector machine 1540 may provide control signals to the MUX 1513 and channel MUX 1519 for the MUX 1513 and channel MUX 1519 to select values to output. The vector machine 1540 may also send a configuration signal to the dot product units 1515A-1515D. The configuration signal may command one of the dot product units 1515A-1515D to operate while the other ones of the dot product units 1515A-1515D may be idle for the clock cycle. In some embodiments, the instructions may come from the memory bank(s). For instance, reset address would contain the instructions. In some embodiments, multiply-adder partitions (e.g., the multiply-adder partitions shown in FIG. 2A) may be placed next to each other to form a matrix multiplication system on a chip. Initially model weights may be placed in the RAM(s), then vector machines of the logic units may be programmed to handle the correct operations as the activations are fed to them.

In addition to the vector machine 1540, type conversions, routing logic, the logic unit 1500 may also include logic (not shown in FIG. 15) that controls or assists with power and clock gating. Clock gating would be used for fine grained power savings where the dot product units (e.g., the dot product units 1515A-1515D) should be turned off for few to a few hundred clocks. Additional power gating may happen when the multiply-adder partitions are large enough. Power gating may also happen at chip level.

In some embodiments, multiply-adders (or logic units with multiply-adders) may be arranged in an array. The array may be referred to as a multiply-accumulate array. The table below shows an example of multiply-adders (or logic units with multiply-adders) arranged in an array having eight rows and four columns. In other embodiments, a multiply-accumulate array may have fewer or more rows or columns.

| | | | |
|---|---|---|---|
| R0_0 | R1_0 | R2_0 | R3_0 |
| R0_1 | R1_1 | R2_1 | R3_1 |
| R0_2 | R1_2 | R2_2 | R3_2 |
| R0_3 | R1_3 | R2_3 | R3_3 |
| R0_4 | R1_4 | R2_4 | R3_4 |
| R0_5 | R1_5 | R2_5 | R3_5 |
| R0_6 | R1_6 | R2_6 | R3_6 |
| R0_7 | R1_7 | R2_7 | R3_7 |

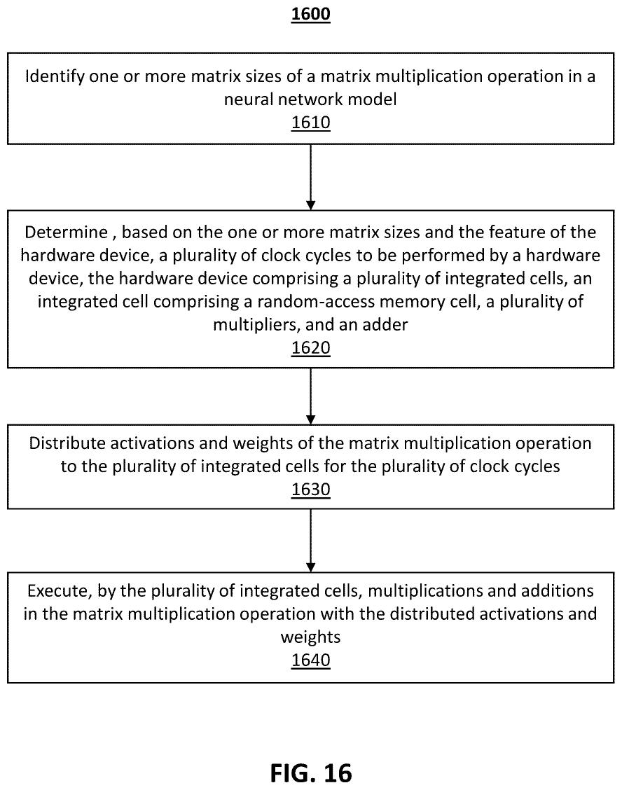

FIG. 16 is a flowchart showing a method 1600 of executing a DNN, in accordance with various embodiments. The method 1600 may be performed by the IC device 100 in FIG. 1. Although the method 1600 is described with reference to the flowchart illustrated in FIG. 16, many other methods for DNN execution may alternatively be used. For example, the order of execution of the steps in FIG. 16 may be changed. As another example, some of the steps may be changed, eliminated, or combined.

The IC device 100 identifies 1610 one or more matrix sizes of a MatMul operation in the DNN. The one or more matrix sizes may include one or more sizes of a weight matrix of the MatMul operation, one or more sizes of an activation matrix of the MatMul operation, or one or more sizes of an output matrix of the MatMul operation. In some embodiments, the MatMul operation is an operation of a feed forward neural network in the DNN.

The IC device 100 determines 1620, based on the one or more matrix sizes and the feature of the hardware device, a plurality of clock cycles to be performed by a hardware device. The hardware device comprises a plurality of integrated cells. An integrated cell comprises a RAM cell, a plurality of multipliers, and an adder. In some embodiments, the hardware device is a dot unit, such as the embedding dot unit 120 in FIG. 1. In some embodiments, the hardware device includes an integrated cell array. In some embodiments, the IC device 100 converts the MatMul operation by adding one or more multiplications or additions of the MatMul operation based on the one or more matrix sizes and the feature of the hardware device. The IC device 100 determines the plurality of clock cycles based on the converted MatMul operation.

The IC device 100 distributes 1630 activations and weights of the MatMul operation to the plurality of integrated cells for the plurality of clock cycles. In some embodiments, the IC device 100 distributes the activations to the plurality of integrated cells for a first clock cycle of the plurality of clock cycles. The activations remain in the plurality of integrated cells for one or more other clock cycles of the plurality of clock cycles. In some embodiments, for each of the plurality of clock cycles, the IC device 100 distributes a different subset of the weights to the plurality of integrated cells. In some embodiments, for each of the plurality of clock cycles, the IC device 100 distributes a different subset of the weights and a different set of the activations to the plurality of integrated cells

The IC device 100 executes 1640, by the plurality of integrated cells, multiplications and additions in the MatMul operation with the distributed activations and weights. In some embodiments, the plurality of integrated cells is to compute different output elements of the MatMul operation in different clock cycles. In some embodiments, the plurality of integrated cells computes intermediate values in the plurality of clock cycles. The hardware device is to accumulate the intermediate values to compute an output element of the MatMul operation.

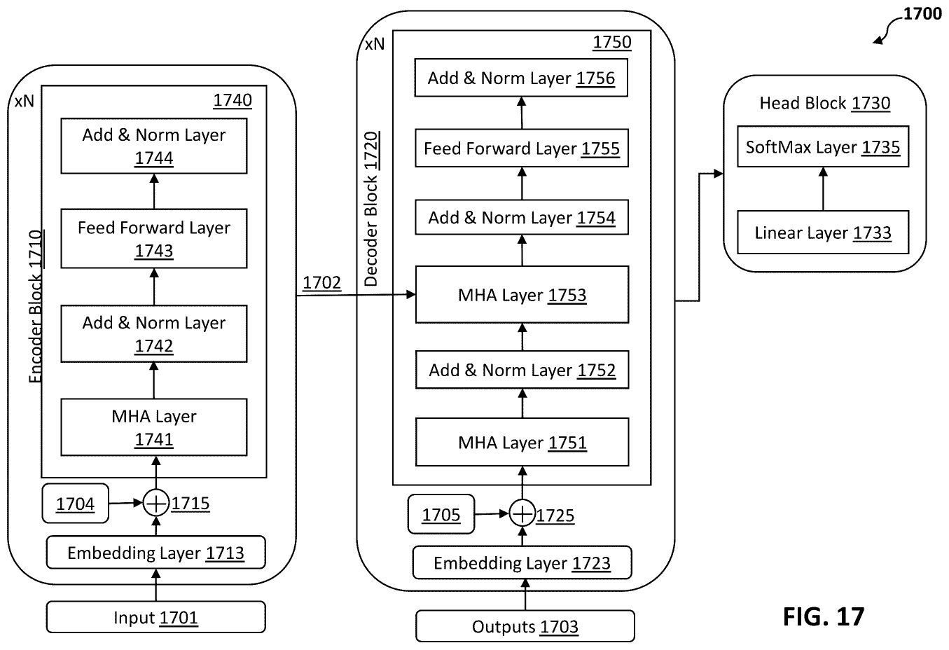

FIG. 17 illustrates an example transformer-based model 1700, in accordance with various embodiments. The transformer-based model 1700 is an example of the DNNs described above. The transformer-based model 1700 may be embedded on a chip. An example of the chip is the IC device 100 in FIG. 1. As shown in FIG. 17, the transformer-based model 1700 includes an encoder block 1710, a decoder block 1720, and a head block 1730. In other embodiment, different or additional components may be included in the transformer-based model 1700. Further, functionality attributed to a component of the transformer-based model 1700 may be accomplished by a different component included in the transformer-based model 1700 or a different model or module.

The encoder block 1710 receives input sequences and generates matrix representations of the input sequences. In the embodiments of FIG. 17, the encoder block 1710 receives an input 1701 and generates an encoder output 1702. The input 1701 may be an input prompt. In some embodiments, the input 1701 may include one or more input tokens, such as words, phrases, sentences, images, audio signals, other types of input tokens, or some combination thereof. In an example, the input 1701 may include a prompt received from a user of the transformer-based model 1700. The prompt may include a question or request made by the user. A word in the prompt may be an input token. In some embodiments, the encoder output 1702 may include one or more vectors that are contextualized representations of the input 1701. Each vector in the encoder output 1702 may represent a token in the input 1701 with contextual understanding.

The encoder block 1710 includes an embedding layer 1713, a positional encoding layer 1715, and a plurality of layers 1740 (individually referred to as “layer 1740”). In other embodiments, the encoder block 1710 may have different, fewer, or more components. Also, the arrangement of the components in the encoder block 1710 may be different from the arrangement shown in FIG. 17. For the purpose of illustration, the encoder block 1710 has N layers in FIG. 17, where N is an integer. Each layer 1740 may include one or more neural network operations. The layers 1740 may transform a sequence of embeddings into a representation that encapsulates the learned information from the input 1701. Different layers 1740 may have different internal parameters, e.g., different weights, bias, or other types of internal parameters. In some embodiments, the layers 1740 have identical components. The components in a layer 1740 may be layers and may also be referred to as sub-layers of the layer 1740. As shown in FIG. 17, a layer 1740 includes four sub-layers: a multi-head attention (MHA) layer 1741, an add & norm layer 1742, a feed forward layer 1743, and another add & norm layer 1744.

The decoder block 1720 iteratively generates outputs 1703 using encoded representations generated by the encoder block 1710. The decoder block 1720 includes an embedding layer 1723, a positional encoding layer 1725, and a plurality of layers 1750 (individually referred to as “layer 1750”). For the purpose of illustration, the decoder block 1720 has N layers in FIG. 17, where N is an integer. In the embodiments of FIG. 17, the number of layers 1750 in the decoder block 1720 is the same as the number of layers 1740 in the encoder block 1710. In other embodiments, the number of layers 1750 in the decoder block 1720 may be different from the number of layers 1740 in the encoder block 1710. Each layer 1750 may include one or more neural network operations. Different layers 1750 may have different internal parameters. In some embodiments, the layers 1750 may have identical components. The components in a layer 1750 may be layers and may also be referred to as sub-layers of the layer 1750. As shown in FIG. 17, a layer 1750 includes six sub-layers: an MHA layer 1751, an add & norm layer 1752, another MHA layer 1753, another add & norm layer 1754, a feed forward layer 1755, and another add & norm layer 1756.

In some embodiments, a sequence of inference stages is performed in the decoder block 1720 using encoder outputs, e.g., the encoder output 1702. A matrix may be predicted through each inference stage. The outputs 1703 may include a plurality of matrices. Each matrix may be further processed in the head block 1730 to predict a token. The plurality of matrices may be used to predict a sequence of tokens. For the first inference stage, the decoder block 1720 may receive one or more start tokens as input tokens and compute a first matrix from the input tokens and the output of the encoder block 1710. The first matrix may be used by the head block 1730 to predict a first token. The predicted token may be used as a new input token, in addition to the start token(s), in the second inference stage. Similarly, a second token may be predicted through the second inference stage and may be used in the third inference stage. This iteration may continue till all the inference stages are complete.

The head block 1730 receives the output of the decoder block 1720 and processes it in a linear layer 1733 and a SoftMax layer 1735. A linear operation may be performed on the output of the decoder block 1720 in the linear layer 1733. The linear operation may include a multiplication of the output of the decoder block 1720 with a weight matrix. The output of the linear layer 1733 may be a vector. In some embodiments, the head block 1730 may function as a classifier. The number of data elements in the vector computed in the linear layer 1733 may depend on the number of classes involved. In an example where there are M classes, where M is an integer, the vector computed in the linear layer 1733 may have M data elements representing the prediction for the M classes, respectively.

The output of the linear layer 1733 may be input into the SoftMax layer 1735. A SoftMax function may be applied on the output of the linear layer 1733 to compute probability scores. A probability score may have a value in the range from 0 to 17. In some embodiments, a probability value is computed for each data element in the vector computed in the linear layer 1733. The highest one of the probability scores may be the key. The corresponding index of the key may point to the token that the transformer-based model 1700 predicts as the next in the sequence. The final output of the transformer-based model 1700 may be the sequence of predicted tokens. In some embodiments, the head block 1730 may be a language modeling head.

An embedding layer (e.g., the embedding layer 1713 or the embedding layer 1723) converts an input of the embedding layer (e.g., the input 1701 or the outputs 1703) into one or more embeddings. An embedding may be a vector, which is also referred to as an embedding vector or a vector embedding. The vector embedding may include a sequence of data elements. In some embodiments, the embedding layer 1713 may generate a plurality of embeddings, each of which may be converted from a different input token in the input 1701. The embeddings may capture the semantic meaning of the tokens in the input 1701. The embeddings may be numerical representations that capture the relationships or meanings of words, phrases, or other data types. In an example where the input 1701 is a prompt including a sequence of words, the embedding layer 1713 may generate an embedding from each word in the input 1701. The embedding layer 1723 in the decoder block 1720 may generate a plurality of embeddings from tokens received by the decoder block 1720 in a similar manner as the embedding layer 1713.

A positional encoding layer (e.g., the positional encoding layer 1715 or the positional encoding layer 1725) performs positional encoding on embeddings generated in the corresponding embedding layer. In some embodiments, the positional encoding layer may apply one or more positional encoding vectors (e.g., a positional encoding vector 1704 or positional encoding vector 1705) on vector embeddings from the corresponding embedding layer to generate new vector embeddings that represent the embeddings with positional context. The positional encoding vector may encode information about the position of the embedding in a sequence of embeddings. In some embodiments, the positional encoding layer performs an addition operation on a positional encoding vector and a vector embedding. The addition operation may be elementwise addition. The positional encoding layer may output an embedding matrix that includes the vector embeddings computed in the positional encoding layer.

An MHA layer (e.g., the MHA layer 1741, the MHA layer 1751, or the MHA layer 1753) may implement a multi-head attention mechanism, which may be a multi-head self-attention mechanism or a multi-head cross-attention mechanism. In some embodiments, the MHA layer 1741 or the MHA layer 1751 may implement a self-attention mechanism. For self-attention, the queries, keys, and values may come from the same place. For instance, for the MHA layer 1741, the queries, keys, and values may all come from the positional encoding layer 1715. For the MHA layer 1751, the queries, keys, and values may all come from the positional encoding layer 1725. The self-attention mechanism may enable the transformer-based model 1700 to relate each token with other tokens. The MHA layer may compute attention scores from embeddings generated in the corresponding positional encoding layer. In some embodiments, the MHA layer may receive one or more queries, one or more keys, and one or more values. In some embodiments, the MHA layer has a number of heads that receive different linearly projected versions of the queries, keys, and values and produce outputs in parallel that are then used to generate the final result.

In some embodiments, the queries, keys, and values input into the MHA layer 1741 may be computed from vector embeddings generated by the positional encoding layer 1715. The queries, keys, and values input into the MHA layer 1751 may be computed from vector embeddings generated by the positional encoding layer 1725. A query key, or value may be a vector the represents a token in a sequence. In some embodiments, a query matrix Q∈ [symbol] ^{N×h} may be computed by multiply an embedding matrix X∈ [symbol] ^{N×d} (e.g., an embedding matrix computed in a positional encoding layer) with a weight matrix W_{q}∈ [symbol] ^{d×h}, where d is the dimension of a vector embedding, N is the number of vector embeddings in the embedding matrix, and h is the number of attention heads. Each row in the query matrix may be a query. A key matrix K∈ [symbol] ^{N×h} may be computed by multiple an embedding matrix X∈ [symbol] ^{N×d} (e.g., an embedding matrix computed in a positional encoding layer) with a weight matrix Wₖ∈ [symbol] ^{d×h}. Each row in the key matrix may be a key. A value matrix V∈ [symbol] ^{N×h} may be computed by multiple an embedding matrix X∈ [symbol] ^{N×d} (e.g., an embedding matrix computed in a positional encoding layer) with a weight matrix Wᵥ∈ [symbol] ^{d×h}. Each row in the value matrix may be a value.

In some embodiments, the MHA layer 1751 may implement masked multi-head self-attention. The MHA layer 1751 may prevent positions from attending to subsequent positions. For instance, each token in the sequence may not be influenced by future tokens. This masking can ensure that the predictions of a particular position can depend on known outputs at positions before it and not depend on unknown outputs at positions after it.

In some embodiments, the MHA layer 1753 may implement a cross-attention mechanism, such as encoder-decoder cross-attention. The MHA layer 1753 may use outputs from the previous layer (i.e., the add & norm layer 1752) as queries and use outputs from the encoder block 1710 as keys and values. The cross-attention can align the encoder's input with the decoder's, empowering the decoder block 1720 to identify and emphasize the most relevant parts of the encoder's input.

In some embodiments, an MHA layer includes linear layers, a MatMul layer, a scale layer, a SoftMax layer, another MatMul layer, a concatenation layer, and another linear layer. These layers may be arranged in a sequence. The MHA layer may receive three input matrices: a query matrix, a key matrix, and a value matrix, which are inputs of three linear layers, respectively. The linear layers may include matrix multiplication (MatMul) operations. For instance, a first linear layer may perform a multiplication of the query matrix with a weight matrix to compute a first parameter matrix. The first parameter matrix may be denoted as

$${QW}_{i}^{Q} ,$$

where Q is the query matrix and

$${W}_{i}^{Q}$$

∈ [symbol] ^{d}^{_{model}}^{×d}^{ₖ} is the weight matrix. A second linear layer may perform a multiplication of the key matrix with a weight matrix to compute a second parameter matrix. The second parameter matrix may be denoted as

$${KW}_{i}^{K} ,$$

where K is the key matrix and

$${W}_{i}^{K}$$

∈ [symbol] ^{d}^{_{model}}^{×d}^{ₖ} is the weight matrix. A third linear layer may perform a multiplication of the value matrix with a weight matrix to compute a third parameter matrix. The third parameter matrix may be denoted as

$${VW}_{i}^{V} ,$$

where V is the value matrix and

$${W}_{i}^{V}$$

∈ [symbol] ^{d}^{_{model}}^{×d}^{ₖ} is the weight matrix. i may indicate the index of the head. d_{q} is the dimension of a query vector. dₖ is the dimension of a key vector. dᵥ is the dimension of a value vector. In some embodiments, d_{q}=dₖ=dᵥ=d_{model}/h. In some embodiments, the linear layers may be in a linear block of the MHA layer. In some embodiments, the MHA layer may include multiple linear blocks. For instance, the MHA layer includes h linear blocks. The linear blocks may have the same layers as each other. Each linear block may compute three parameter matrices from the query matrix, key matrix, and value matrix, respectively.

The MatMul layer, scale layer, mask layer, SoftMax layer, and MatMul layer may be in an attention block of the MHA layer. The attention block may implement a scaled dot product attention mechanism. In some embodiments, the MHA layer includes a plurality of attention blocks that includes the attention block. For the purpose of illustration, the MHA layer includes h attention blocks. The attention blocks may have the same layers as each other. A linear block and an attention block may constitute a head of the MHA layer. When the MHA layer has h linear blocks and h attention blocks, the MHA layer has h heads. A head may be denoted as

$${head}_{i} = Attention ( {QW}_{i}^{Q} , {KW}_{i}^{K} , {VW}_{i}^{V} ) .$$

A matrix multiplication operation may be performed on parameter matrices in the MatMul layer, which computes a score matrix. In some embodiments, the score matrix may establish the degree of emphasis each token should place on other tokens. The score matrix may include a plurality of scores. Each token may be assigned a score in relation to other tokens within the same time step. A higher score may indicate a higher focus or emphasis. The score matrix may be scaled in the scale layer. In some embodiments, the score matrix is scaled down in the scale layer by dividing the scores in the score matrix by the square root of the dimension of the query vector and the key vector, which may be denoted as \sqrt{dₖ}. The output of the scale layer may be a scaled matrix, which includes adjusted scores. The mask layer may be optional in some embodiments. The mask layer may add an attention mask (which may be an input to the attention block) to the output of the scale layer to mask out some elements in the output of the scale layer. The positions of the masked-out elements may be defined by the attention mask. A SoftMax function may be applied on the scaled matrix in the SoftMax layer to compute an attention weight matrix. The attention weight matrix includes attention weights. The attention weights may be probability values ranging from 0 to 1. The SoftMax function may emphasize high scores while diminishing low scores, which can enhance the model's ability to determine which tokens should get more attention.

In the MatMul layer, a matrix multiplication operation is performed on the attention weight matrix computed in the SoftMax layer and the parameter matrix computed from value matrix in the corresponding linear layer. The result of the matrix multiplication operation is a single-head output matrix, which is an output of the attention block.

When the MHA layer has h attention blocks, there may be h single-head output matrices. The single-head output matrices are concatenated in the concatenation layer to form a concatenated matrix. A linear operation (also referred to as “linear transformation”) is performed on the concatenated matrix using a weight matrix in the linear layer. In some embodiments, the MHA may be denoted as MultiHead(Q, K, V)=Concat (head₁, head₂, . . . , headₕ)W^{O}, where Concat denotes concatenation, and W^{O}∈ [symbol] ^{hd}^{ᵥ}^{×d}^{_{model}} is the weight matrix in the corresponding linear layer.

An add & norm layer in the transformer-based model 1700, such as the add & norm layer 1742, 1744, 1752, 1754, and 1756, has an addition operation followed by a layer normalization operation. The addition operation may be an addition of the output of the preceding layer and the input of the preceding layer. The preceding layer is a layer that is arranged right before the add & norm layer. For example, the preceding layer of the add & norm layer 1742 is the MHA layer 1741. As another example, the preceding layer of the add & norm layer 1754 is the MHA layer 1753.

Then the layer normalization operation is applied on the result of the addition operation, which may be denoted as LayerNorm(x+sublayer(x)), where LayerNorm denotes layer normalization, x is the input of the preceding layer, and sublayer(x) denotes the output of the preceding layer. In some embodiments, the layer normalization operation may include a sequence of computations. In an example, the layer normalization operation may include a mean computation, which may be denoted as

$${μ}_{xy} = \frac{1}{Z} \times {\sum }_{z = 1}^{Z} {A}_{xyz} ,$$

where A_{xyz} denotes a data element in the input tensor, x may be the positional index of the data element in one of the spatial dimensions, y may be the positional index of the data element in the other one of the spatial dimensions, z may be the positional index of the data element in the channel dimension, and μ_{xy} denotes the output of the mean computation, which may be a 2D matrix. The mean computation may be channel-wise reduction operation. The layer normalization operation may convert μ_{xy} to a 3D tensor μ_{xyz}, e.g., by replicating every data element over z output points.

The layer normalization operation may also include an elementwise subtraction, which may be denoted as D_{xyz}=A_{xyz}−μ_{xyz}. The layer normalization operation may further include a variance computation denoted as

$${σ}_{xy}^{2} = {\sum }_{z = 1}^{Z} {D}_{xyz}^{2}$$

and a division computation denoted as

$${M}_{xy} = \frac{1}{\sqrt{\frac{1}{Z} \times ( {σ}_{xy}^{2} + ϵ \times Z )}} .$$

M_{xy} may be a 2D tensor. The layer normalization operation may also convert M_{xy} to a 3D tensor M_{xyz}, e.g., by replicating every data element over z output points. Further, the layer normalization operation may have an element multiplication denoted as

$${A}_{xyz}^{′} = \frac{{A}_{xyz} - {μ}_{xyz}}{\sqrt{\frac{1}{Z} \times ( {σ}_{xy}^{2} + ϵ )}} = ( {A}_{xyz} - {μ}_{xyz} ) \times \frac{1}{\sqrt{\frac{1}{Z} \times ( {σ}_{xy}^{2} + ϵ )}} = {D}_{xyz} \times {M}_{xyz} .$$

The layer normalization operation may further compute

$${A}_{xyz}^{″} = {A}_{xyz}^{′} + \frac{{β}_{z}}{{γ}_{z}} and {LN}_{xyz} = {A}_{xyz}^{″} \times {γ}_{z} \cdot {LN}_{xyz}$$

may be the output of the layer normalization operation.

A feed forward layer (e.g., the feed forward layer 1743 and the feed forward layer 1755) may be a position-wise fully-connected feed forward network. In an example, the feed forward layer may include two linear layers with an activation function in between. An example of the activation function is Rectified Linear Unit (ReLU).

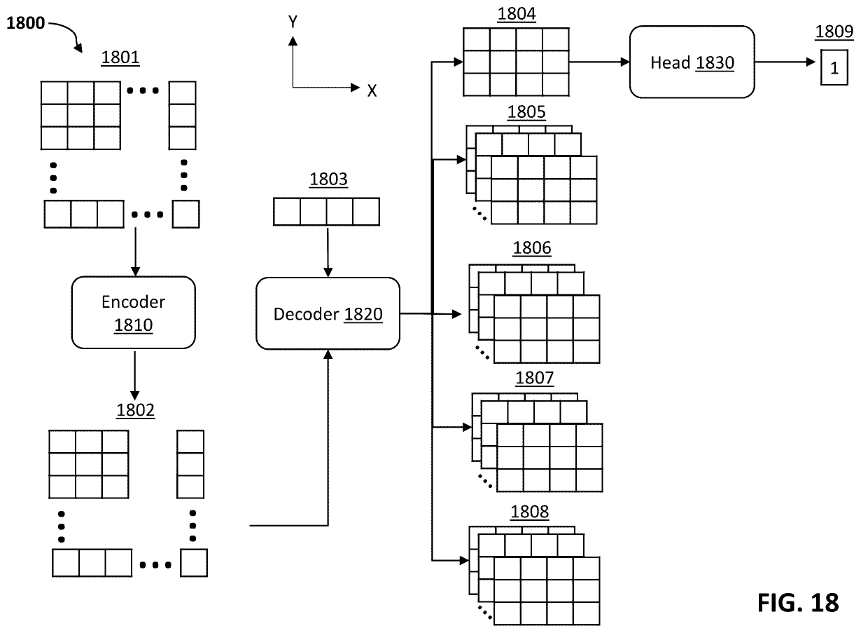

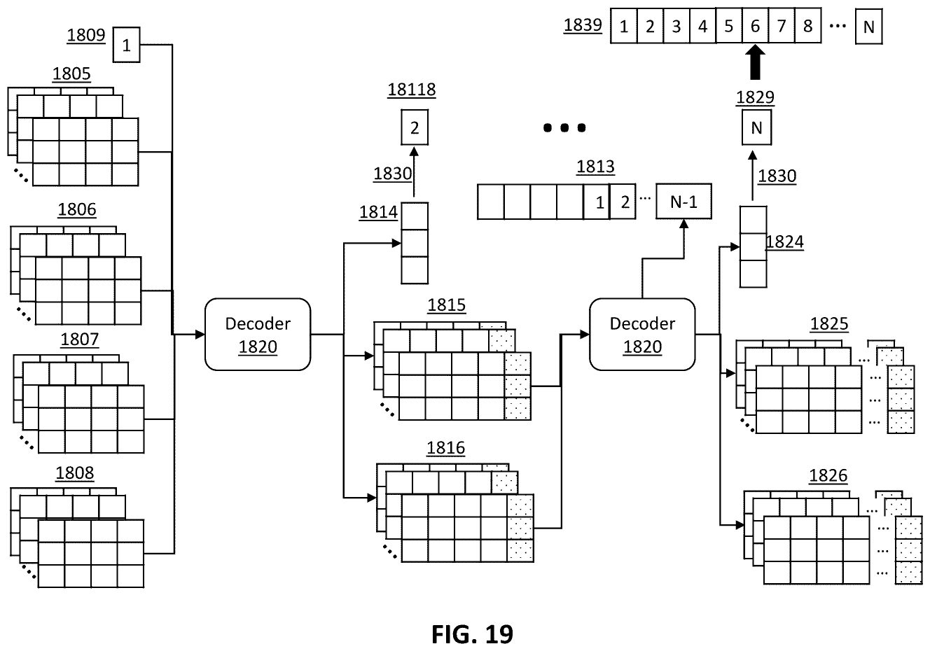

FIGS. 18 and 19 illustrate inferences of a transformer model 1800, in accordance with various embodiments. FIG. 18 illustrates the first inference process of the transformer model 1800, in accordance with various embodiments. The transformer model 1800 includes an encoder 1810, a decoder 1820, and a head 1830. An example of the transformer model 1800 may be the transformer-based model 1700 in FIG. 17. In the embodiments of FIG. 18, the encoder 1810 receives an input tensor 1801. The input tensor 1801 may be a feature map extracted from one or more images, text documents, audio files, videos, other types of data, or some combination thereof. The encoder 1810 generates an output tensor 1802 from the input tensor 1801. The shape of the output tensor 1802 may be denoted as [batch size,SL_{encoder}, d_{model}], where SL_{encoder} may be the dimension along the X axis (i.e., the width of the output tensor 1802), and d_{model} may be the dimension along the Y axis (i.e., the height of the output tensor 1802). The encoder 1810 may include a plurality of layers arranged in a sequence, such as the layers inside the encoder 1810 in FIG. 17. The output tensor 1802 is provided to the decoder 1820.

The decoder 1820 receives the output tensor 1802 and an input sequence 1803. The input sequence 1803 may be a sequence of tokens. A token may be a numerical representation of an input signal, such as word, image, audio signal, video signal, etc. The dimension of the input sequence 1803, which may be denoted as SLᵢₙₚᵤₜ, may be the total number of tokens in the input sequence 1803. For the purpose of illustration and simplicity, SLᵢₙₚᵤₜ is 4. In other embodiments, the input sequence 1803 may have a different shape. For instance, the input sequence 1803 may be a 2D tensor. The dimension of the 2D tensor along the X axis may be SLᵢₙₚᵤₜ, while the dimension of the 2D tensor along the Y axis may be a batch size indicating the number of batches in the input sequence 1803.

The decoder 1820 computes an output tensor 1804, a self-attention key tensor 1805, a self-attention value tensor 1806, a cross-attention key tensor 1807, and a cross-attention value tensor 1808. In some embodiments, the shape of the output tensor 1804 may be denoted as [batch size, SLᵢₙₚᵤₜ, d_{model}]. The shape of the self-attention key tensor 1805 or the shape of the self-attention value tensor 1806 may be denoted as N×[batch size, h, SLᵢₙₚᵤₜ, d_{head}], where N is the number of identical layers in the decoder 1820 (e.g., the number of layers in the decoder 1820), h is the total number of heads in a MHA layer, and d_{head} is the dimension of a query vector, key vector, or value vector. In some embodiments, d_{model}=h×d_{head}. The shape of the cross-attention key tensor 1807 or the shape of the cross-attention value tensor 1808 may be denoted as N×[batch size, h,SL_{encoder}, d_{head}].

The output tensor 1804 may be provided to the head 1830 and the head 1830 outputs a predicted token 1809. The shape of the token 1809 may be denoted as [batch size, 1]. For the purpose of illustration and simplicity, batch size is 1 in FIG. 18. In other embodiments, batch size may be a larger number. The predicted token 1809 may be stored in a buffer. In some embodiments, the predicted token 1809 may be used to update the input sequence 1803. For instance, the predicted token 1809 may be added to the right of the input sequence 1803. The updated input sequence may be used as the input sequence in the second inference phase. In the second inference phase, the decoder 1820 may receive the updated input sequence and the output tensor 1802 for predicting another token. The output tensor 1802 may remain the same during inference of the decoder 1820. Certain aspects of subsequent inference processes are described below in conjunction with FIG. 19.

In some embodiments, the self-attention key tensor 1805 and the self-attention value tensor 1806 may be provided to a self-attention layer in the decoder 1820, an example of such a self-attention layer is the MHA layer 151. The self-attention key tensor 1805 may be stored in a self-attention key cache. The self-attention key cache may have the same shape as the self-attention key tensor 1805. The self-attention value tensor 1806 may be stored in a self-attention value cache. The self-attention value cache may have the same shape as the self-attention value tensor 1806.

In some embodiments, the decoder 1820 computes the self-attention key tensor 1805 and the self-attention value tensor 1806 from the input sequence 1803. The input sequence 1803 may be dynamic during inference of the decoder 1820. For instance, a new token may be added to the input sequence 1803 after each inference phase, as described above. As the input sequence 1803 changes, the self-attention key tensor 1805 and the self-attention value tensor 1806 would also change. For instance, the dimension of the self-attention key tensor 1805 or the self-attention value tensor 1806 along the X axis may increase as SLᵢₙₚᵤₜ increases. The self-attention key cache and the self-attention value cache may change during all the inference phases of the decoder 1820 to accommodate the changes in the self-attention key tensor 1805 and the self-attention value tensor 1806.

In some embodiments, the cross-attention key tensor 1807 and the cross-attention value tensor 1806 may be provided to a cross-attention layer in the decoder 1820, an example of such a cross-attention layer is the MHA layer 153. The cross-attention key tensor 1807 may be stored in a cross-attention key cache. The cross-attention key cache may have the same shape as the cross-attention key tensor 1807. The cross-attention value tensor 1808 may be stored in a cross-attention value cache. The cross-attention value cache may have the same shape as the cross-attention value tensor 1808. In some embodiments, the decoder 1820 computes the cross-attention key tensor 1807 and the cross-attention value tensor 1806 from the output tensor 1802 generated in the encoder 1810. As the output tensor 1802 does not change during inference of the decoder 1820, the cross-attention key tensor 1807 and the cross-attention value tensor 1806 may remain the same during all the inference phases of the decoder 1820. The cross-attention key cache and the cross-attention value cache may remain the same during all the inference phases of the decoder 1820.

FIG. 19 illustrates subsequent inference processes of the transformer model 1800, in accordance with various embodiments. In the second inference phase, the decoder 1820 may reuse the self-attention key tensor 1805, self-attention value tensor 1806, cross-attention key tensor 1807, and cross-attention value tensor 1808. The decoder 1820 also receives the predicted token 1809. The decoder 1820 may compute self-attention key vectors from the predicted token 1809 and concatenate the self-attention key vectors with the self-attention key tensor 1805 to generate a new self-attention key tensor 1815. For instance, a self-attention key vector for each head may be added to the right of a self-attention key matrix in the self-attention key tensor 1805, and the self-attention key vector and the self-attention key matrix may correspond to the same head. The elements highlighted with a dot pattern in the self-attention key tensor 1815 are the self-attention key vectors generated from the predicted token 1809.

Similarly, the decoder 1820 may compute self-attention value vectors from the predicted token 1809 and concatenate the self-attention value vectors with the self-attention value tensor 1806 to generate a new self-attention value tensor 1816. For instance, a self-attention value vector for each head may be added to the right of a self-attention value matrix in the self-attention value tensor 1806, and the self-attention value vector and the self-attention value matrix may correspond to the same head. The elements highlighted with a dot pattern in the self-attention value tensor 1816 are the self-attention value vectors generated from the predicted token 1809.

The decoder 1820 also generates an output tensor 1814. The decoder 1820 may generate the output tensor 1814 using the new self-attention key tensor 1815 and new self-attention value tensor 1816. The output tensor 1814 is used by the head 1830 to generate another predicted token 1819. The predicted token 1819 is the output of the transformer model 1800 in the second inference phase.

One or more other subsequent inference processes may be conducted. In each subsequent inference phase, the decoder 1820 receives a token predicted in the previous inference phase, a self-attention key tensor generated in the previous inference phase, a self-attention value tensor generated in the previous inference phase, the cross-attention key tensor 1807, and the cross-attention value tensor 1808. The decoder 1820 may, in the subsequent inference phase, generate a larger self-attention key tensor and a larger self-attention value tensor, in addition to an output tensor which can be used by the head 1830 to predict a new token.

In embodiments where the total number of inference phases is N, the input sequence 1803 is updated to an input sequence 1813 after N−1 inference phases. In the last inference phase (i.e., the Nth inference phase), the decoder 1820 may receive the predicted token generated in the (N−1)th inference phase, the self-attention key tensor generated in the (N−1)th inference phase, the self-attention value tensor generated in the (N−1)th inference phase, the cross-attention key tensor 1807, and the cross-attention value tensor 1808. The decoder 1820 may generate a self-attention key tensor 1825 and a self-attention value tensor 1826 using the predicted token generated in the (N−1)th inference phase, the self-attention key tensor generated in the (N−1)th inference phase, and the self-attention value tensor generated in the (N−1)th inference phase. The dimensions of the self-attention key tensor 1825 or self-attention value tensor 1826 along the X axis is SLᵢₙₚᵤₜ+N. The decoder 1820 also generates an output tensor 1824, which is used by the head 1830 to generate the last predicted token 1829. The N tokens predicted by the transformer model in the N inference phases may constitute an output tensor 1839, which may be the final output of the transformer model.

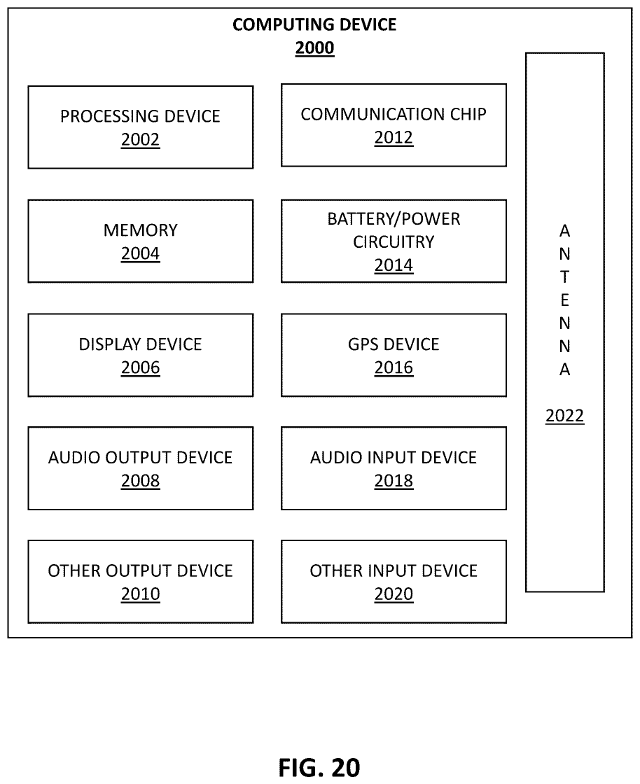

FIG. 20 is a block diagram of an example computing device 2000, in accordance with various embodiments. A number of components are illustrated in FIG. 20 as included in the computing device 2000, but any one or more of these components may be omitted or duplicated, as suitable for the application. In some embodiments, some or all of the components included in the computing device 2000 may be attached to one or more motherboards. In some embodiments, some or all of these components are fabricated onto a single system on a chip (SoC) die. Additionally, in various embodiments, the computing device 2000 may not include one or more of the components illustrated in FIG. 20, but the computing device 2000 may include interface circuitry for coupling to the one or more components. For example, the computing device 2000 may not include a display device 2006, but may include display device interface circuitry (e.g., a connector and driver circuitry) to which a display device 2006 may be coupled. In another set of examples, the computing device 2000 may not include an audio input device 2018 or an audio output device 2008 but may include audio input or output device interface circuitry (e.g., connectors and supporting circuitry) to which an audio input device 2018 or audio output device 2008 may be coupled.

The computing device 2000 may include a processing device 2002 (e.g., one or more processing devices). The processing device 2002 processes electronic data from registers and/or memory to transform that electronic data into other electronic data that may be stored in registers and/or memory. The computing device 2000 may include a memory 2004, which may itself include one or more memory devices such as volatile memory (e.g., DRAM), nonvolatile memory (e.g., ROM, high-bandwidth memory (HBM), flash memory, solid state memory, and/or a hard drive. In some embodiments, the memory 2004 may include memory that shares a die with the processing device 2002. In some embodiments, the memory 2004 includes one or more non-transitory computer-readable media storing instructions executable to perform operations for DNN execution, such as operations performed by the IC device 100 in FIG. 1 or the method 1600 in FIG. 16. The instructions stored in the one or more non-transitory computer-readable media may be executed by the processing device 2002.

In some embodiments, the computing device 2000 may include a communication chip 2012 (e.g., one or more communication chips). For example, the communication chip 2012 may be configured for managing wireless communications for the transfer of data to and from the computing device 2000. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not.

The communication chip 2012 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication chip 2012 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 2012 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 2012 may operate in accordance with Code-division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 2012 may operate in accordance with other wireless protocols in other embodiments. The computing device 2000 may include an antenna 2022 to facilitate wireless communications and/or to receive other wireless communications (such as AM or FM radio transmissions).

In some embodiments, the communication chip 2012 may manage wired communications, such as electrical, optical, or any other suitable communication protocols (e.g., the Ethernet). As noted above, the communication chip 2012 may include multiple communication chips. For instance, a first communication chip 2012 may be dedicated to shorter-range wireless communications such as Wi-Fi or Bluetooth, and a second communication chip 2012 may be dedicated to longer-range wireless communications such as global positioning system (GPS), EDGE, GPRS, CDMA, WiMAX, LTE, EV-DO, or others. In some embodiments, a first communication chip 2012 may be dedicated to wireless communications, and a second communication chip 2012 may be dedicated to wired communications.

The computing device 2000 may include battery/power circuitry 2014. The battery/power circuitry 2014 may include one or more energy storage devices (e.g., batteries or capacitors) and/or circuitry for coupling components of the computing device 2000 to an energy source separate from the computing device 2000 (e.g., AC line power).

The computing device 2000 may include a display device 2006 (or corresponding interface circuitry, as discussed above). The display device 2006 may include any visual indicators, such as a heads-up display, a computer monitor, a projector, a touchscreen display, a liquid crystal display (LCD), a light-emitting diode display, or a flat panel display, for example.

The computing device 2000 may include an audio output device 2008 (or corresponding interface circuitry, as discussed above). The audio output device 2008 may include any device that generates an audible indicator, such as speakers, headsets, or earbuds, for example.

The computing device 2000 may include an audio input device 2018 (or corresponding interface circuitry, as discussed above). The audio input device 2018 may include any device that generates a signal representative of a sound, such as microphones, microphone arrays, or digital instruments (e.g., instruments having a musical instrument digital interface (MIDI) output).

The computing device 2000 may include a GPS device 2016 (or corresponding interface circuitry, as discussed above). The GPS device 2016 may be in communication with a satellite-based system and may receive a location of the computing device 2000, as known in the art.

The computing device 2000 may include another output device 2010 (or corresponding interface circuitry, as discussed above). Examples of the other output device 2010 may include an audio codec, a video codec, a printer, a wired or wireless transmitter for providing information to other devices, or an additional storage device.

The computing device 2000 may include another input device 2020 (or corresponding interface circuitry, as discussed above). Examples of the other input device 2020 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 2000 may have any desired form factor, such as a handheld or mobile computer system (e.g., a cell phone, a smart phone, a mobile internet device, a music player, a tablet computer, a laptop computer, a netbook computer, an ultrabook computer, a personal digital assistant (PDA), an ultramobile personal computer, etc.), a desktop computer system, a server or other networked computing component, a printer, a scanner, a monitor, a set-top box, an entertainment control unit, a vehicle control unit, a digital camera, a digital video recorder, or a wearable computer system. In some embodiments, the computing device 2000 may be any other electronic device that processes data.

The following paragraphs provide various examples of the embodiments disclosed herein.

Example 1 provides an apparatus for executing a DNN model, the apparatus including one or more integrated cells, an integrated cell of the one or more integrated cells including a RAM cell, the RAM cell to store weights of a matrix multiplication operation of the DNN model, and one or more dot product units coupled with the RAM cell, a dot product unit including a plurality of multipliers to receive the weights from the RAM cell and to multiply the weights with activations of the matrix multiplication operation, and an adder coupled with the plurality of multipliers, the adder to compute a sum of products computed by the plurality of multipliers.

Example 2 provides the apparatus of example 1, in which the one or more dot product units include a first dot product unit to perform computations of a first data type and a second dot product unit to perform computations of a second data type, the second data type different from the first data type.

Example 3 provides the apparatus of example 2, in which the first dot product unit and the second dot product unit are to output values of a same data type.

Example 4 provides the apparatus of any one of examples 1-3, in which the integrated cell further includes an additional adder coupled with the one or more dot product units, the additional adder to accumulate an output of the one or more dot product units with a value received from another integrated cell.

Example 5 provides the apparatus of example 4, in which the integrated cell further includes a MUX, in which the MUX is between the one or more dot product units and the adder along a data path within the integrated cell.

Example 6 provides the apparatus of any one of examples 1-5, in which the apparatus further includes an interconnect fabric, the interconnect fabric for transferring data from the integrated cell to an additional integrated cell of the apparatus.

Example 7 provides the apparatus of any one of examples 1-6, further including a control unit to: manage a data transfer operation of transferring the weights from the RAM cell to the one or more dot product units; and detect whether the data transfer operation has any error.

Example 8 provides the apparatus of any one of examples 1-7, in which the integrated cell further includes a counter, the counter to control an iteration through a plurality of RAM cells of the apparatus for fetching the weights from the RAM cell to the one or more dot product units, the plurality of RAM cells including the RAM cell.

Example 9 provides the apparatus of any one of examples 1-8, in which the integrated cell further includes one or more MUXs coupled with the plurality of multipliers, the one or more MUXs to select the activations of the matrix multiplication operation from activations of a plurality of matrix multiplication operations of the DNN model.

Example 10 provides the apparatus of any one of examples 1-9, in which the apparatus is to operate in a sequence of clock cycles for executing the matrix multiplication operation, the integrated cell to process different subsets of the weights in different clock cycles of the sequence of clock cycles, in which the integrated cell is to process the activations in each clock cycle of the sequence of clock cycles.

Example 11 provides one or more non-transitory computer-readable media storing instructions executable to perform operations, the operations including identifying one or more matrix sizes of a matrix multiplication operation in a DNN model; determining, based on the one or more matrix sizes and the feature of a hardware device, a plurality of clock cycles to be performed by the hardware device, the hardware device including a plurality of integrated cells, an integrated cell including a RAM cell, a plurality of multipliers, and an adder; distributing activations and weights of the matrix multiplication operation to the plurality of integrated cells for the plurality of clock cycles; and executing, by the plurality of integrated cells, multiplications and additions in the matrix multiplication operation with the distributed activations and weights.

Example 12 provides the one or more non-transitory computer-readable media of example 11, in which determining the plurality of clock cycles includes converting the matrix multiplication operation by adding one or more multiplications or additions of the matrix multiplication operation based on the one or more matrix sizes and the feature of the hardware device; and determining the plurality of clock cycles based on the converted matrix multiplication operation.

Example 13 provides the one or more non-transitory computer-readable media of example 11 or 12, in which the matrix multiplication operation is an operation of a feed forward neural network in the DNN model.

Example 14 provides the one or more non-transitory computer-readable media of any one of examples 11-13, in which the plurality of integrated cells is to compute different output elements of the matrix multiplication operation in different clock cycles.

Example 15 provides the one or more non-transitory computer-readable media of example 14, in which distributing the activations and weights includes distributing the activations to the plurality of integrated cells for a first clock cycle of the plurality of clock cycles, in which the activations remain in the plurality of integrated cells for one or more other clock cycles of the plurality of clock cycles; and for each of the plurality of clock cycles, distributing a different subset of the weights to the plurality of integrated cells.

Example 16 provides the one or more non-transitory computer-readable media of any one of examples 11-13, in which the plurality of integrated cells computes intermediate values in the plurality of clock cycles, the hardware device to accumulate the intermediate values to compute an output element of the matrix multiplication operation.

Example 17 provides the one or more non-transitory computer-readable media of example 16, in which distributing the activations and weights includes for each of the plurality of clock cycles, distributing a different subset of the weights and a different set of the activations to the plurality of integrated cells.

Example 18 provides a method, including identifying one or more matrix sizes of a matrix multiplication operation in a DNN model; determining, based on the one or more matrix sizes and the feature of a hardware device, a plurality of clock cycles to be performed by the hardware device, the hardware device including a plurality of integrated cells, an integrated cell including a RAM cell, a plurality of multipliers, and an adder; distributing activations and weights of the matrix multiplication operation to the plurality of integrated cells for the plurality of clock cycles; and executing, by the plurality of integrated cells, multiplications and additions in the matrix multiplication operation with the distributed activations and weights.

Example 19 provides the method of example 18, in which determining the plurality of clock cycles includes converting the matrix multiplication operation by adding one or more multiplications or additions of the matrix multiplication operation based on the one or more matrix sizes and the feature of the hardware device; and determining the plurality of clock cycles based on the converted matrix multiplication operation.

Example 20 provides the method of example 18 or 19, in which the matrix multiplication operation is an operation of a feed forward neural network in the DNN model.

Example 21 provides the method of any one of examples 18-20, in which the plurality of integrated cells is to compute different output elements of the matrix multiplication operation in different clock cycles.

Example 22 provides the method of example 21, in which distributing the activations and weights includes distributing the activations to the plurality of integrated cells for a first clock cycle of the plurality of clock cycles, in which the activations remain in the plurality of integrated cells for one or more other clock cycles of the plurality of clock cycles.

Example 23 provides the method of example 21 or 22, in which distributing the activations and weights includes for each of the plurality of clock cycles, distributing a different subset of the weights to the plurality of integrated cells.

Example 24 provides the method of any one of examples 18-20, in which the plurality of integrated cells computes intermediate values in the plurality of clock cycles, the hardware device to accumulate the intermediate values to compute an output element of the matrix multiplication operation.

Example 25 provides the method of example 24, in which distributing the activations and weights includes for each of the plurality of clock cycles, distributing a different subset of the weights and a different set of the activations to the plurality of integrated cells.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art can recognize. These modifications may be made to the disclosure in light of the above detailed description.

1. An apparatus for executing a neural network model, the apparatus comprising:
one or more integrated cells, an integrated cell of the one or more integrated cells comprising:
a random-access memory (RAM) cell, the RAM cell to store weights of a matrix multiplication operation of the neural network model, and
one or more dot product units coupled with the RAM cell, a dot product unit comprising:
a plurality of multipliers to receive the weights from the RAM cell and to multiply the weights with activations of the matrix multiplication operation, and
an adder coupled with the plurality of multipliers, the adder to compute a sum of products computed by the plurality of multipliers.

2. The apparatus of claim 1, wherein the one or more dot product units include a first dot product unit to perform computations of a first data type and a second dot product unit to perform computations of a second data type, the second data type different from the first data type.

3. The apparatus of claim 2, wherein the first dot product unit and the second dot product unit are to output values of a same data type.

4. The apparatus of claim 1, wherein the integrated cell further comprises an additional adder coupled with the one or more dot product units, the additional adder to accumulate an output of the one or more dot product units with a value received from another integrated cell.

5. The apparatus of claim 4, wherein the integrated cell further comprises a multiplexer, wherein the multiplexer is between the one or more dot product units and the adder along a data path within the integrated cell.

6. The apparatus of claim 1, wherein the apparatus further comprises an interconnect fabric, the interconnect fabric for transferring data from the integrated cell to an additional integrated cell of the apparatus.

7. The apparatus of claim 1, further comprising:
a control unit to:
manage a data transfer operation of transferring the weights from the RAM cell to the one or more dot product units; and
detect whether the data transfer operation has any error.

8. The apparatus of claim 1, wherein the integrated cell further comprises a counter, the counter to control an iteration through a plurality of RAM cells of the apparatus for fetching the weights from the RAM cell to the one or more dot product units, the plurality of RAM cells including the RAM cell.

9. The apparatus of claim 1, wherein the integrated cell further comprises one or more multiplexers coupled with the plurality of multipliers, the one or more multiplexers to select the activations of the matrix multiplication operation from activations of a plurality of matrix multiplication operations of the neural network model.

10. The apparatus of claim 1, wherein the apparatus is to operate in a sequence of clock cycles for executing the matrix multiplication operation, the integrated cell to process different subsets of the weights in different clock cycles of the sequence of clock cycles, wherein the integrated cell is to process the activations in each clock cycle of the sequence of clock cycles.

11. One or more non-transitory computer-readable media storing instructions executable to perform operations, the operations comprising:
identifying one or more matrix sizes of a matrix multiplication operation in a neural network model;
determining, based on the one or more matrix sizes and a feature of a hardware device, a plurality of clock cycles to be performed by the hardware device, the hardware device comprising a plurality of integrated cells, an integrated cell comprising a random-access memory cell, a plurality of multipliers, and an adder;
distributing activations and weights of the matrix multiplication operation to the plurality of integrated cells for the plurality of clock cycles; and
executing, by the plurality of integrated cells, multiplications and additions in the matrix multiplication operation with the distributed activations and weights.

12. The one or more non-transitory computer-readable media of claim 11, wherein determining the plurality of clock cycles comprises:
converting the matrix multiplication operation by adding one or more multiplications or additions of the matrix multiplication operation based on the one or more matrix sizes and the feature of the hardware device; and
determining the plurality of clock cycles based on the converted matrix multiplication operation.

13. The one or more non-transitory computer-readable media of claim 11, wherein the matrix multiplication operation is an operation of a feed forward neural network in the neural network model.

14. The one or more non-transitory computer-readable media of claim 11, wherein the plurality of integrated cells is to compute different output elements of the matrix multiplication operation in different clock cycles.

15. The one or more non-transitory computer-readable media of claim 14, wherein distributing the activations and weights comprises:
distributing the activations to the plurality of integrated cells for a first clock cycle of the plurality of clock cycles, wherein the activations remain in the plurality of integrated cells for one or more other clock cycles of the plurality of clock cycles; and
for each of the plurality of clock cycles, distributing a different subset of the weights to the plurality of integrated cells.

16. The one or more non-transitory computer-readable media of claim 11, wherein the plurality of integrated cells computes intermediate values in the plurality of clock cycles, the hardware device to accumulate the intermediate values to compute an output element of the matrix multiplication operation.

17. The one or more non-transitory computer-readable media of claim 16, wherein distributing the activations and weights comprises:
for each of the plurality of clock cycles, distributing a different subset of the weights and a different set of the activations to the plurality of integrated cells.

18. A method, comprising:
identifying one or more matrix sizes of a matrix multiplication operation in a neural network model;
determining, based on the one or more matrix sizes and a feature of a hardware device, a plurality of clock cycles to be performed by the hardware device, the hardware device comprising a plurality of integrated cells, an integrated cell comprising a sequential read-only memory cell, a plurality of multipliers, and an adder;
distributing activations and weights of the matrix multiplication operation to the plurality of integrated cells for the plurality of clock cycles; and
executing, by the plurality of integrated cells, multiplications and additions in the matrix multiplication operation with the distributed activations and weights.

19. The method of claim 18, wherein the plurality of integrated cells is to compute different output elements of the matrix multiplication operation in different clock cycles.

20. The method of claim 18, wherein the plurality of integrated cells computes intermediate values in the plurality of clock cycles, the hardware device to accumulate the intermediate values to compute an output element of the matrix multiplication operation.
